(19) United States
(12) Patent Application Publication
(10) Pub. No.: US 2009/0071834 A1
(43) Pub. Date: Mar. 19, 2009

(54) Methods and Devices for Concentration and Fractionation of Analytes for Chemical Analysis Including Matrix-Assisted Laser Desorption/Ionization (MALDI) Mass Spectrometry (MS)

(75) Inventors: Dean G. Hafeman, Hillsborough, CA (US); James B. Harkins, IV, Knoxville, TN (US); Jeremy L. Norris, Knoxville, TN (US); Sheila N. Baker, Knoxville, TN (US); Donald R. Loveday, Knoxville, TN (US); Daniel P. Kuban, Knoxville, TN (US); Richard M. Caprioli, Brentwood, TN (US); Charles E. Witkowski, II, Knoxville, TN (US); Benjamin B. Katz, Knoxville, TN (US); Salvadore J. Pastor, Knoxville, TN (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: PROTEIN DISCOVERY, INC., Knoxville, TN (US)

(21) Appl. No.: 12/136,021

(22) Filed: Jun. 9, 2008

Related U.S. Application Data
(60) Provisional application No. 60/943,023, filed on Jun. 8, 2007.

(51) Int. Cl. G01N 27/447

(52) U.S. Cl. 204/641

(57) ABSTRACT

A device is described for pre-concentration and purification of analytes from biological samples (such as human serum, plasma, homogenized solid tissue, etc.) to be analyzed by Matrix-Assisted Laser Desorption Ionization Mass Spectrometry (MALDI MS) and methods of use thereof are provided.

This application claims the benefit of priority from U.S. Provisional Application No. 60/943,023, filed Jun. 8, 2007, the disclosure of which is explicitly incorporated by reference herein. The disclosures of each of U.S. application Ser. No. 10/963,336, filed Oct. 12, 2004, U.S. application Ser. No. 11/278,799, filed Apr. 5, 2006, and U.S. application Ser. No. 11/636,412, filed Dec. 8, 2006, filed Dec. 8, 2005, are also explicitly incorporated by reference.

### BACKGROUND OF THE INVENTION

1. Field of the Invention

The present invention relates to Mass Spectrometry (MS) and, more specifically, to pre-concentration and purification of analytes from biological samples, such as human serum, to be analyzed by Matrix-Assisted Laser Desorption Ionization Mass Spectrometry (MALDI MS).

2. Background of the Invention

Devices and methods are disclosed to facilitate the concentration and capture of proteins, peptides and other analyte molecules onto a solid capture phase from the mobile phase of electrophoretic concentrator cells. Further such solid capture phases are adaptable for direct analysis in a mass spectrometer. Mass spectrometry allows multiple analytes to be monitored simultaneously, in contrast to most other analytical techniques that quantify only one, or at most, just a few different molecules at a time. Recent advances in mass spectrometry; such as lower cost instrumentation, improved ease of use, and high throughput MALDI methods; promise to revolutionize clinical research, and then as a result the entire healthcare industry. A key to realizing this tremendous potential, however, is the development of new sample preparation technologies capable of preparing complex biological samples for mass spectrographic analysis rapidly and reproducibly. Such technologies need to accommodate a wide variety of samples including solids including tissue homogenates, whole tissue slices or other solid tissue preparations, as well as liquid samples such as whole blood, plasma, serum, cerebrospinal fluid, saliva, urine and the like. Serum is perhaps the most clinically important biological fluid, with hundreds of millions of samples taken by vacuum tube yearly for medical diagnoses. Blood and lymphatic fluids are rich sources of disease biomarkers because, in addition to natural blood-borne proteins & polypeptides circulating in blood and lymph fluids, body tissues release additional cellular components into the blood and lymph streams. Thus these circulating fluids contain disease biomarkers including proteins & polypeptides (PP) that are indicative of pathological conditions, such as cellular hyperplasia, necrosis, apoptosis, or shedding of antigens from neoplastic tissue. Here the term PP is used to refer to oligopeptides or proteins of broad molecular weight range including the range of from two, or more, amino acids (i.e., of approximately 200 Daltons) to high molecular weight proteins (of about 1 million Daltons, or more).

An especially promising class of disease markers in serum are the low molecular weight (LMW) PP fragments whose abundances and structures change in ways indicative of many, if not most, human diseases (Tirumalai et al., 2003, Characterization of the Low Molecular Weight Human Serum Proteome, Molecular & Cellular Proteomics 2: 1096-103). The LMW serum proteome is made up of several classes of physiologically important polypeptides, such as cytokines, chemokines, peptide hormones, as well as proteolytic fragments of larger proteins. These proteolytically-derived peptides have been shown to correlate with pathological conditions such as cancer, diabetes and cardiovascular and infectious diseases. Analysis of the LMW serum proteome, however, requires extensive sample preparation and is notoriously difficult to analyze due to the large proportion of albumin (˜55%) that dominates the total amount of protein in blood serum. Other problems include the wide dynamic range in abundance of other LMW PP molecules, and the tremendous heterogeneity of the dominant glycoproteins. For example, the rarest proteins now measured clinically (FIG. 1) are present at concentrations more than 10 orders of magnitude lower than albumin (Anderson et al., 2002, The Human Plasma Proteome, Molecular and Cellular Proteomics 1: 845-67). These rare proteins and peptides, however, are believed to represent highly sensitive and selective disease markers and potential drug targets.

Traditionally, liquid chromatography (LC) or affinity-based methods have been used to the greatest extent to provide for a suitable separation process. Purification via LC methods involves chemically attaching linker molecules to a stationary phase (producing a functionalized stationary phase) in a LC column. Once the sample is loaded into the column, a mobile phase is flowed through the stationary phase. The fraction of the time each analyte spends bound to the stationary phase, rather than in the mobile phase, determines the relative migration rate of different analytes (as well as contaminants and interfering species) through the LC column, providing for purification of the analytes. For example, analyte molecules of interest, such as peptides and proteins, can be adsorbed onto a functionalized stationary phase while the contaminants are eluted from the column. Next, the mobile phase is adjusted so as to release the molecules of interest from the functionalized stationary phase. Often, a volatile buffer that is compatible with MALDI-MS, such as an acetonitrile/water mixture, is used as the mobile phase in this step. In this fashion, the purified molecules of interest are eluted from the LC column and collected for MALDI-MS analysis. The sample is now relatively free of salts and other contaminants that would otherwise interfere or otherwise limit the sensitivity of the analysis. There is a need therefore, for improved devices and procedures for separating, concentrating and adding reagents needed for analysis of samples during high throughput methods of analysis. Recent reviews of sample preparation techniques for mass spectrometry show that these methods remain time-consuming, cumbersome, require highly skilled labor and are difficult to automate (Westermeier et al., 2002, In: Proteomics in Practice (Wiley-VCH Verlay-GbmH, Weinheim); Hamdan et al., 2005, In: Proteomics Today (John Wiley & Sons, Hoboken, N.J.)). As a result, the number of samples that can be analyzed within any one clinical study is extremely limited, thus substantially hindering the level of statistical significance and, therefore, clinical relevance, of these studies. Consequently, principally due to the lack of sample preparation systems the LMW serum proteome is an excellent, largely unexplored, source of biomarkers (detectable by mass spectrometery) for disease, disease treatment and gene expression analysis in humans, as well as other animals.

Matrix-assisted laser desorption/ionization mass spectrometry (MS) analysis of samples deposited onto MALDI target plates is rapidly becoming a method of choice for analysis of proteins, peptides and other biological molecules. The MALDI-MS procedure is a very sensitive analytical method and is probably the MS procedure most compatible with biological salts and pH buffers. Further, its ability to generate high-mass ions at high efficiency from sub-picomole quantities of biological macromolecules makes this technique extremely useful for macromolecule analysis. Analysis of peptide analytes in crude biological samples, such as blood, plasma, or serum, however offers special problems for mass spectrometry analysis as described below.

The first problem to be overcome is that the biological samples contain high concentrations of salts (e.g., sodium, potassium, chloride, phosphate and carbonate). The anions especially are effective in suppressing the ionization of peptide samples by the usual MALDI analysis procedures. The cations also are problematic in that they generate adduct spectra that split the primary mass peaks of proteins into a multitude of additional mass peaks each having the additional mass of one cation. Also, the success of MALDI-MS analysis depends to a great extent on the ability of the analyst technician to effectively crystallize a MALDI matrix substance mixed together with the analyte prior to injection into the mass spectrometer. The MALDI matrix substance is needed to absorb the laser light that provides for atomization and ionization of the matrix together with adsorbed analyte substances within samples to be analyzed. The ionized analyte molecules then are accelerated into a mass spectrometer ion detector by a high electrical field provided by high voltages on an anode and cathode within the mass spectrometer. When even relatively small amounts of contaminants (such as salts or glycerol) are present the ability of MALDI matrices to efficiently desorb and ionize analytes, such as proteins and peptides, is dramatically reduced. Furthermore, high salt concentrations increase both the threshold laser intensity required for MALDI-MS and the intensity of salt-adducted peptide peaks (at the expense of free peptide peaks).

Secondly, in samples, such as human serum, analyte peptides are frequently present at very low copy number compared to interfering proteins (e.g., albumin, immunoglobulins and transferrin). The peptides of interest often are present at just 1 micromole per liter to 1 picomole per liter (e.g., 1 microgram to 1 picogram per ml). In contrast total albumin and gamma globulins such as IgG, IgM, are present at levels ranging from 0.01 to 0.1 grams per ml, i.e., up to 1×10¹¹-fold greater in mass. Thus, the major abundance proteins heavily dominate MALDI spectra of the mixture. Minor components are rarely observed because the low intensity peaks are obscured by the major peaks. This problem is made much more difficult in biological samples, such as human serum where such low copy number molecules need to be detected in the presence of many orders of magnitude higher molar concentrations of interfering proteins (e.g., albumin, immunoglobulins and transferrin) and salts (e.g., sodium, potassium, chloride, phosphate and carbonate).

Thirdly, many of the analyte peptides are hydrophobic and are bound to the major proteins found in blood, plasma, or serum. Albumin especially tends to bind hydrophobic molecules nonspecifically. Thus, removal of the unwanted proteins such as albumin also results in the loss of analyte peptides. Chemically disruptive agents, such as salts and detergents are known to assist in the dissociation of analyte peptides from albumin. These agents actively suppress the MALDI process however. For example polyethylene glycol (PEG) and Trition ionize and desorb by MALDI as efficiently as peptides and proteins. As a result these species often compete with ionization of proteins and peptides and thereby suppress the MALDI-MS signals from the latter. Thus, after the addition of chemically disruptive agents to dissociate analyte peptides from albumin, the analyst must separate the analyte peptides from both the disruptive agent's albumin and other contaminating proteins. Additionally, the separation must be performed in such a way that the minor component peptide analytes are not lost during the separation process. This separation is made especially difficult when the analytes are hydrophobic and tend to adhere to hydrophobic surfaces. Unfortunately, purification of biopolymers by LC methods frequently results in 30%, or greater, sample losses and can add contaminants (or sample “cross-talk” to samples. For most MALDI-MS users, this amount of sample loss is unacceptable. Fourth, because the analyte peptides are present at such low levels, they must be concentrated prior to MALDI-MS analysis. Carrying out first the dissociation of peptides, the separation of components, and then the concentration, by prior art methods is tedious and requires multiples steps that are both time-consuming and labor-intensive.

### SUMMARY OF THE INVENTION

One aspect of the present invention therefore is to provide methods and devices to remove salts from biological samples. A second aspect of the invention is to remove high abundance molecules, such as proteins, from biological samples thereby allowing reproducible and sensitive analysis of the remaining low abundance molecules. A third aspect of the invention is to dissociate analyte peptides from albumin and other hydrophobic proteins. A fourth object of the invention is to concentrate analyte peptides and proteins of interest for MALDI mass spectrometry analysis. A fifth object of the invention is to provide the first four objects of the invention in a convenient and effective manner, so as to provide for high sample throughput. A sixth object of the invention is to provide for handling a multiplicity of samples simultaneously, so that two-or more samples may be analyzed in parallel. Thereby, in combination with the other objects of the invention, an analyst will be able to utilize the instant invention to perform analysis of peptides and proteins in biological tissue samples in a convenient and efficient manner, thereby increasing the sensitivity of detection, increasing the sample throughput, as well as decreasing the cost of analysis. Lastly, there is a desire for analysis of the separated analyte peptides, polypeptides and proteins (analytes) to be done reproducibly and quantitatively. Thus a seventh object of the invention is to provide for reproducible and quantitative MALDI-MS analysis of peptides and proteins in biological samples. The methods and devices of the invention may also be used to capture small charged molecules, such as drugs and metabolites, from a sample.

Employing the term PP to refer to oligopeptides ranging from small size of two, or more, amino acids to large proteins of 1 million Daltons, or more, an eighth object of the invention is to provide an analysis system to examine the LMW fraction of PP in human serum by mass spectrometry (MS). A ninth object of the invention is to provide a Protein/Polypeptide Analysis System (PPAS) with sufficient versatility that that a wider range of PP, for example from 500 Daltons to 500,000 Daltons, or more, also can be analyzed by mass spectrometry (MS). A tenth object of the invention is to provide improvements to the PPAS to further increase the sensitivity of detection so that quantities of PP from 1 nanomole to 0.1 attomole, or less, can be detected, quantified and molecular weight measured by MS. An eleventh object of the invention is to provide for increased fractionation and separation of PP in human serum so that low abundance PP can be separated from higher-abundance PP prior to MS analysis thus providing increased sensitivity of detection of the low abundance PP.

### BRIEF DESCRIPTION OF THE DRAWINGS

FIG. 1: The Human Plasma Proteome shows the challenge of analyzing proteins and polypeptides present in serum as they span a range in concentrations of over 10 orders in magnitude (figure adapted from Anderson et al., 2002, The Human Plasma Proteome, Molecular and Cellular Proteomics 1, 845-67).

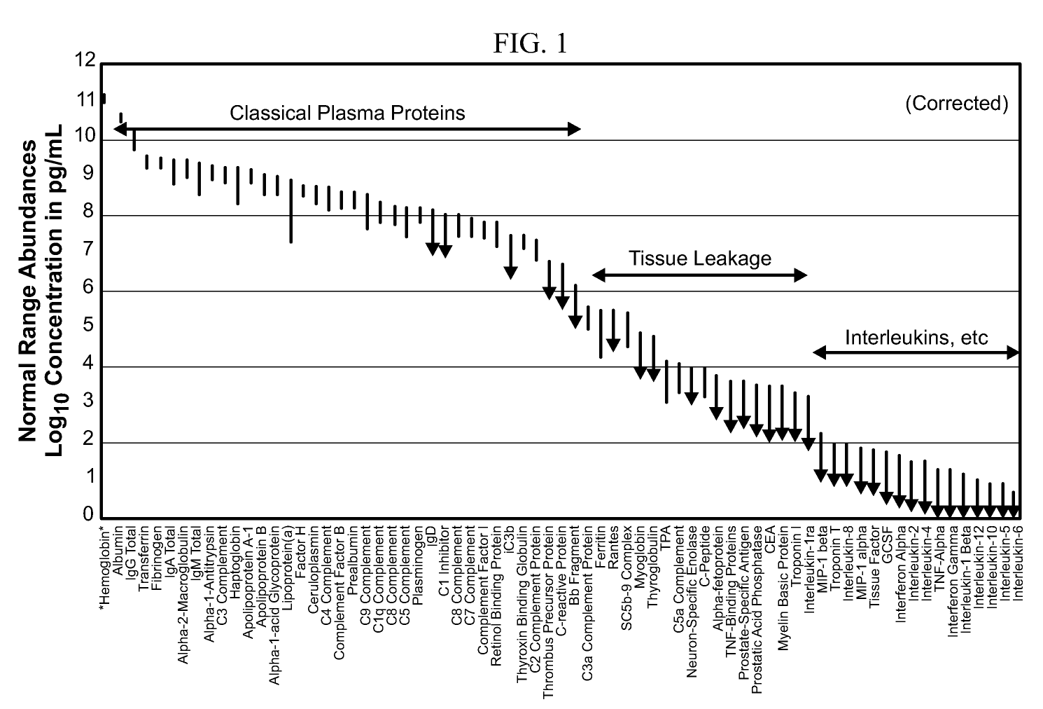

FIG. 2: Schematic cut-away drawing of a single well of an Analysis System. In a preferred embodiment, the Analysis System has an 8×12 array of 96 sample wells contained within a cartridge.

FIG. 3: Schematic drawing of an array of Sample Wells comprising the Cartridge in a preferred embodiment of the Analysis System.

FIG. 4: An embodiment of Capture Slide 42 showing Apertures 50 inserted into a MALDI Slide Holder 90 having a Mechanical Guide 92.

FIG. 5A: Slide-Washing Manifold for Applying Pressure-Driven Fluid Flow Across Capture Slide.

FIG. 5B: Electrophoretic Slide-Washing Apparatus for Maintaining an Electrolyte in Contact with the Capture Materials on a Capture Slide and for Applying an Electric Field in the Electrolyte Across the Capture Materials.

FIG. 6: A plot of Polypeptide Standards at 1 pmol and BSA at ˜127 pmol on Steel MALDI Target Plate.

FIG. 7: A plot of Polypeptide Standards at 0.1 pmol and BSA at ˜127 pmol on Steel MALDI Target Plate.

FIG. 8: A plot of Polypeptide Standards at 0.1 pmol and BSA at ˜127 pmol concentrated with albumin depletion within a PPAS Device.

FIG. 9: MALDI Mass Spectra of Serum Proteins.

FIG. 10: Binary pH Fraction using the PPAS Device.

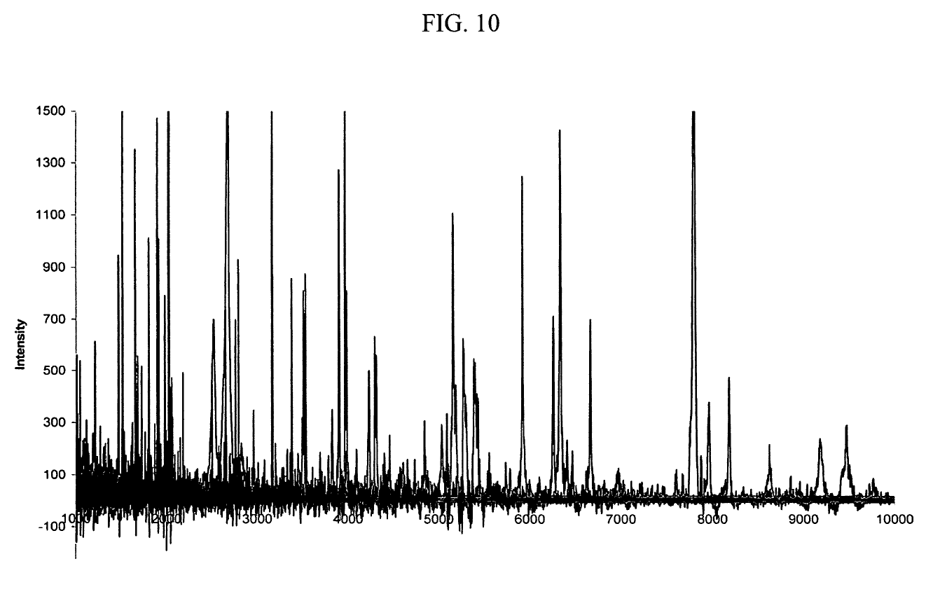

FIG. 11: Mass Spectrometry Results from the Analysis of Positively Charged LMW Proteins in Human Serum obtained with an Alpha Prototype of the Protein/Polypeptide Analysis System (PPAS) having a Single Capture Membrane as the Capture Material.

FIG. 12: Mass Spectrometry Results from the Analysis of Negatively Charged LMW Proteins in Human Serum obtained with an Alpha Prototype of the Protein/Polypeptide Analysis System (PPAS) having a Single Capture Membrane as the Capture Material.

FIG. 13: Chemical structures of (a) Gleevec and (b) d8-Gleevec.

FIG. 14: Mass spectrometry (linear mode, MALDI TOF MS) results from Gleevec quantitation; upper panel shows Gleevac+d8-Gleevca at 5000 ng/mL and 12.5 ng (25.3 pmol) loaded in well and lower panel shows d8-Gleevac only at 5000 ng/mL.

FIG. 15: Mass spectrometry analysis from Gleevec quantitation showing that over the range of concentrations tested, Gleevac demonstrated a linear response, and that using these conditions, the limit of detection is about 625 ng/mL, which translates into 3.13 ng (6.33 pmol) Gleevac loaded into the well.

### DETAILED DESCRIPTION OF THE INVENTION

Incorporated in its entirety, by reference herein, is U.S. patent application Ser. No. 10/963,336, filed Oct. 12, 2004, which discloses methods and devices for use in the field of the invention. The methods and capture slides of this invention may be used in association with the apparatuses and methods disclosed therein. The methods and capture slides of this invention further may be used in association with the apparatuses disclosed in U.S. application Ser. No. 11/636,412, filed Dec. 8, 2006, which is incorporated herein in its entirety by reference.

A useful embodiment of the invention is a Peptide and Protein Analysis System (PPAS) that electrophoretically separates, concentrates and captures low abundance proteins and polypeptides present in biological samples such as serum (or from other tissues) onto a solid-phase capture slide. Following a brief rinse step, salts and other interfering molecules are washed away. Then, a MALDI matrix solution is applied to the capture slide. As is well known in the prior art, such matrix solutions, generally containing an organic solvent, release the proteins for incorporation into MALDI matrix crystals that precipitate on the slide surface upon drying of the solvent. Next the slide is dried completely and inserted directly into a MALDI-MS instrument for quantification of both the mass and the relative abundance of the captured proteins.

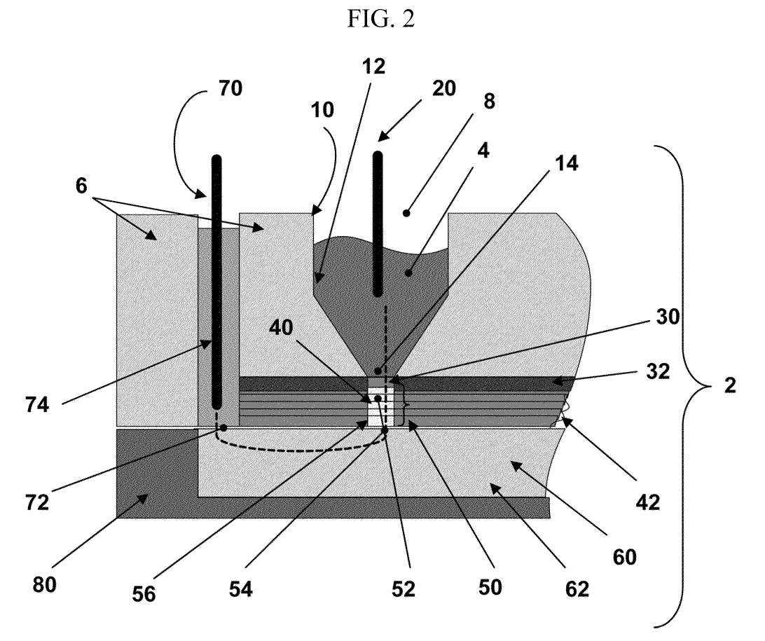

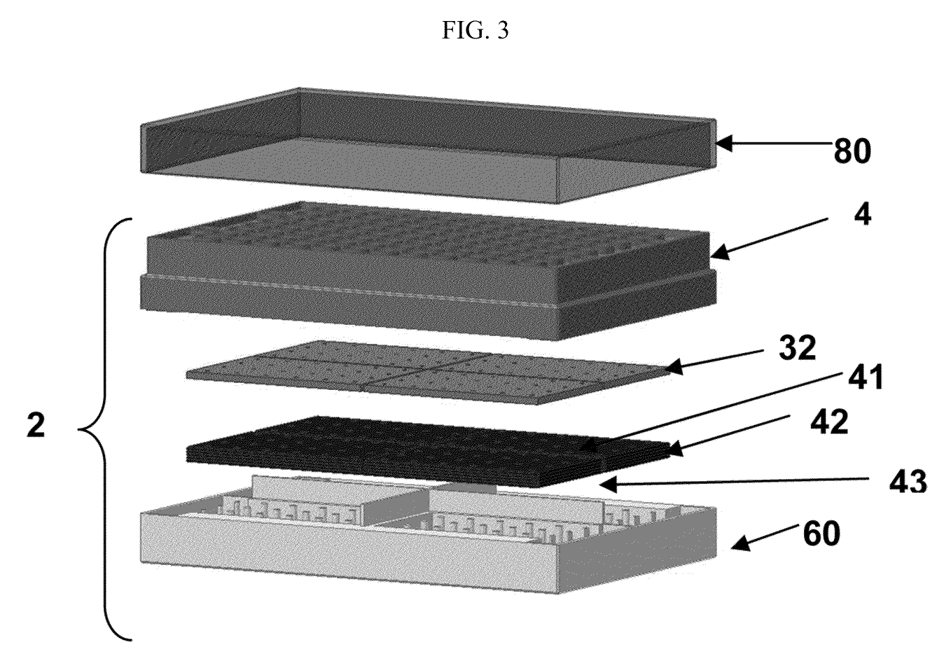

As shown in detail in FIGS. 2 and 3 the PPAS is comprised of a cartridge 2 having one, or more wells 4 for retaining fluid samples. One embodiment of the cartridge 2 includes twenty-five (25) sample wells for processing twenty-five (25) samples simultaneously. A preferred embodiment of the cartridge 2 includes ninety-six (96) sample wells in an 8×12 array for processing ninety-six (96) samples simultaneously. In the preferred embodiment the capture slides 42 and reagents needed to perform a separation and capture are predisposed as an array of sample wells 4 within cartridge 2. FIG. 3 shows an array of sample wells 4 comprising the cartridge 2. FIG. 2 shows a schematic drawing in a cut-away view of one well of a multi-well PPAS cartridge 2.

Each sample well 4 has a top opening 8, side walls 10 the bottom portion 12 which are progressively reduced in dimension from a wide top opening 8 to a narrow bottom opening 14. The top opening 8 of the sample wells 4 accepts a sample electrode 20 that makes electrical contact with electrolyte samples placed within the sample wells, as shown in FIG. 2. The sample electrode 20, which in a preferred embodiment is provided as an array of sample electrodes, removably fits into a top opening 8 of each sample well 4. The array of sample electrodes is designed to be reusable and cleanable by simply rinsing the assembly with DI water, or other suitable solvent, prior to each use. Optionally a more stringent cleaning may be performed either with detergents, strong acids, e.g., those below pH 2.0, or strong bases, e.g., those above pH 12.0, or organic solvents e.g., methanol, ethanol, acetonitrile, acetone, CS₂, dimethylformamide, dimethylsulfoxide, or the like.

The bottom portion 12 of each of the sample wells is shaped so as to continuously decrease the cross-sectional area near the bottom opening 14 of each sample well. In a preferred embodiment the bottom well portion is conical in shape so as to focus protein molecules into a bottom opening 14 of reduced area at the bottom of each sample well. Below the bottom opening 14 is a separation layer 30 that serves to separate the sample wells 4 from capture material 40. The separation layer 30 functions to retain selected first sample molecules either within the sample wells 4, or within the separation layer 30, while allowing selected second sample molecules to pass through the separation layer into contact capture material 40 where the second sample molecules are captured concentrated.

In a preferred embodiment of the invention the separation layer is comprised of a gel layer such as a polyacrylamide gel. Such gels generally have from 1% to 24% polyacrylamide, and also have various amounts of cross linkers and polymerization initiators and are well known to those skilled in the art of protein separations. Further in preferred embodiments having an array of sample wells 4, a corresponding array of substantially identical separation layers 30 will be present, preferably disposed within a cartridge gel plate 32, where the array of separation layers 30 is contained within an array of substantially identical apertures 34 disposed on a cartridge gel plate 32. In general, gel plate 32 is formed by machining, molding or casting from a desired material, such as thermoplastic polymers (polyurethane, polypropylene, and the like). Such gel plates will be electrically-insulating, flexible polymers, e.g., thermoset polymers, elastomers, or rubber materials. In general such flexible material offers good liquid-sealing properties, while also providing electrical isolation between sample wells 4. The separation layer 30 also serves to isolate the sample wells 4 from the one, or more, capture material 40 that serves to capture and concentrate analyte molecules that are electrophoretically driven through the separation layer 30. Advantageously separation layer 30 is covalently bound to plate 32. Such covalent attachment prevents loss of adhesion and facilitates assembly of the cartridge assembly. As mentioned above, a particularly useful separation layer for isolation of proteins in liquid media is polyacrlyamide. Thus, covalent attachment of polyacrylamide to its supporting structure surfaces is particularly useful. The chemical bonding of polyacrylamide to a solid polyacrylamide supporting structure serves both to form a physically strong composite structure and also to form tight liquid seal between the polyacryamide and the supporting structure. In the instant case the bond is formed between the polyacrylamide separation layer 30 and gel plate 32, specifically within the area defined by gel plate apertures 34. In a method to carry out such covalent attachment of polyacrylamide to its supporting surface, or surfaces, a polyacrlyamide reaction mixture is deposited within the gel plate apertures 34 within gel plate 32, followed by a chemical grafting step. A particularly robust and durable polyacrylamide separation layer 30 may be photografted to gel plate 32 by photographing according a basic two-step reaction sequence. Both reaction steps may be performed by using solutions containing monomers of acrylamide and bis acrylamide in contact with the supporting surfaces. Initiation of both polymerization (within the bulk reaction mixture) and attachment of polyacrylamide to a surfaces of a supporting structure, e.g., the gel plate 32, is provided by using ultraviolet radiation or alternatively chemical initiators. Conveniently a physical retainer approximately the size of the gel plate may be used to retain both the gel plate and the reaction solutions containing the monomers. Further the reaction mixture may be retained in contact with the supporting structure by a thin sheet of material that is held in approximation with the supporting structure by physical means such a vacuum clamp.

In a preferred embodiment, first the solid surface to which polyacrylamide is to be attached is pretreated with a photografting reaction mixture. Subsequently, chemical grafting of polyacrylamide to the supporting surfaces and polymerization of the bulk polyacrylamide mixture may be preformed simultaneously. For example, the grafting and polymerization reactions both may be initiated by UV-irradiation in situ. In a preferred mode, a presoaking step is employed that comprises adsorption of a photoinitiator to the gel plate material prior to the polymerization. The presoaking step, for example may comprise substeps of a) employing a presoak solution containing a type II photoinitiator followed by b) drying of the gel plate, for example in dry gas such as air. Alternatively the gas may be heated to employ drying.

Type II photoinitiators are commercially available, such as from Sigma-Aldrich Company. Generally, type II photoinitiators undergo a biomolecular where the excited state of the photoinitiator interacts with a second molecule (a coninitiator) to generate free radicals. Examples include benzophenones/amines thioxanthones/amines.

A particular example of a type II photoinitiator presoak solution is 0.006% (by mass) thioxanthen-9-one in methanol. In the preferred mode the attachment and polymerization processes discussed above are carried out by placing a reaction mixture onto the surfaces, forming a low- to no-oxygen environment by vacuum sealing the mold, and irradiating the mixture with UV energy for a time sufficient to generate copolymer molecules which are covalently bound to the interior surface of the wells. With ordinary sources of UV energy (such as a 5000-EC unit from Dymax Corporation Torrington, Conn., USA fitted with a H-lamp) generally the irradiation time will be between 1 second and 1 hour. Alternatively, with very intense sources of UV, or flash sources, the irradiation time may be very brief, e.g., from 1 microsecond to 1 second, or less. Still other suitable sources of UV irradiation include mercury arc lamps.

Additional types of materials suitable for use as polyacrylamide supporting structures to which polyacrylamide can be chemically bonded additionally include polyurethane, Santoprene, polypropylene, and the like. In general any polymeric material containing abstractable hydrogen atoms at its surface, i.e., in its backbone or side-chain moieties, will be a suitable polymeric material for carrying out the subject invention. By way of example, the abstractable hydrogen may be in the form of a doubly allylic hydrogen, an allylic hydrogen, a tertiary hydrogen, or a secondary hydrogen. Specific examples include but are not limited to polymers made from or containing polyolefins, hydrogenated polystyrene, cyclic olefin copolymer, poly (ethyleneterephthalate), nylon, polycarbonate, poly(vinyl chloride), polybutylmethacrylate, polystyrene, poly(dimethyl siloxane), or poly(methyl methacrylate). Additional photoinitiators for initiating the bonding process generally include type II photoinitiators, well known to those skilled in the art, that have the property of partitioning to the surface of the solid polymer to be grafted (rather than into the bulk polyacrlyamide polymerization reaction mixture).

In a preferred mode the combined photografting and bulk polymerization mixture consists of approximately 68.7% volume aqueous buffering solution, 30% volume of a 40% (w/v) solution of acrylamide/N,N′-Methylenebisacrylamide present in a 19:1 ratio) in deionized water, 0.69% volume of a 0.6% (w/v) Thioxanthen-9-one in methanol, 0.41% volume of a 1% (w/v) ammonium persulfate in deionized water and 0.20% volume of 1,2-Di(dimethylamino)ethane (TEMED) (or EDMA). The reaction mixture is mixed and placed into a shallow container having a glass or polymer bottom surface. Particularly useful as such bottom surfaces are “non-stick” surfaces, e.g., Teflon®. The “nonstick” surfaces act to facilitate release of the polyacrylamide from the bottom surface following the bonding of polyacrylamide to its desired solid supporting structure contained within the container, e.g., the gel plate 32. In the procedure, the gel plate is placed into the combined photografting and bulk polymerization mixture and covered with a UV-transparent cover, such as UV-transparent glass or a thin polymer plate such that gel plate apertures 34 contain the reaction mixture while air bubbles are excluded. The construct comprising a UV-transparent plate, polyacrylamide reaction mixture and bonding supporting structure mechanically are held in place by binder clips, a vacuum clamp, or other suitable clamping means. A photomask may be used over the UV-transparent plate covering the gel plate such that only desired portions of the reaction mixture and supporting structures are illuminated by the UV light source. Thereby the polyacrylamide may be bound to the its supporting surfaces in a predetermined pattern. For initiation of photopolymerization the construct is placed into proximity of a UV irradiation device and irradiated for a suitable time, depending upon the wavelength and intensity of the irradiation. The time of irradiation is dependent on system factors, but is generally less than four minutes where the irradiation flux is 150 mW/cm² of irradiated surface area. Sufficient UV radiation is provided for example by a 5000-EC unit from Dymax Corporation Torrington, Conn., USA using a D-lamp operating at a distance of approximately 20 cm from the gel plate surface. After UV irradiation, the UV-transparent cover is removed and the polyacrylamide, being chemically bonded to a solid supporting structure (e.g., gel plate 32) by photografting, is removed from the container and rinsed with a suitable rinse solvent, such as deionized water, in order to remove any nonpolymerized reaction mixture. The resulting polyacrylamide/supporting structure unitary part (e.g., polyacrylamide gel bound to the gel plate) then is placed in an appropriate liquid medium, or sealed package for storage, or immediately is assembled into a cartridge for use. Supported polyacrylamide gels made in situ show excellent mechanical stability and good adhesion to the supporting material. The simultaneous polymerization process described above is particularly convenient to carry out so as to manufacture such chemically-bonding supported acrylamide structures in time-efficient manner.

Optionally, the polyacrylamide reaction mixture may contain contain additional useful ligands, for example, proteins, polysaccharides, DNA, RNA, or the like. Such ligands conveniently may be added to the polyarylamide reaction mixture, prior to polymerization. Alternatively, the ligands may be added to the polyacrylamide after polymerization, either by allowing sufficient time for diffusion of the ligands from an adjacent soaking solution, or by active electrophoresis from the soaking solution into the attached polyacrlyamide. For example, if desired, a modified carbohydrate material may be added to the polyacrylamide for the purpose of enhancing the retention of albumin by the polyacrylamide. Examples of such materials include blue dextran, protein-affinity modified silicas, or other materials that are known to those skilled in the art to bind albumin.

### Capture Slides

The capture material 40 is disposed at orifices 50 located in cartridge capture slides 42, having a top surface 41 and a bottom surface 43. The orifices 50 have a top opening 52, at top surface 41 and a bottom opening 54 at bottom surface 43. The orifices 50 also comprise internal wall surfaces 56 of capture slides 42. Capture material 40 is attached to the capture slides 42, generally at internal wall surfaces 56 of the orifices 50. The attachment is effected by a bonding means, which may include welding, either by solvent, thermal, sonic or other welding means. Alternatively the capture material 40 may be attached to the capture slides 42 at the orifices 50 by means of covalent chemical bonding employing epoxy, methacrylate, cyanoacrylate, or other types of chemical bonding materials and resins.

In a preferred embodiment of a cartridge capture slide 42 containing 96 orifices 50 (also referred to as apertures) for holding capture material 40, the cartridge capture slide 42 is between about 4 and about 6 mm in length, between about 3 and about 4 mm in width, and about 1 mm in thickness. More preferably, the cartridge capture slide 42 is about 5.3 mm long, about 3.5 mm wide, and about 1 mm thick. Also preferably, the orifices 50 are substantially circular and are about 0.5 to about 1.0 mm in diameter. Similar dimensions apply to the preferred cartridge gel plate 32. In a particularly preferred embodiment, an additional gel plate 32 without gels in orifices 50 is employed to support the cartridge capture slide 42. The additional gel plate 32 is positioned between the cartridge capture slide 42 and electrolyte base chamber 60.

As shown in FIGS. 2 and 3, under the cartridge capture slide 42 is an electrolyte base chamber 60 that functions to physically isolate and electrically connect the individual cartridge wells from each other and also from one, or more, common counter electrodes 70 in corresponding one, or more, counter-electrode chambers 72. When ready for use, electrolyte base chamber 60 is filled with a conductive electrolyte base medium 62 and counter-electrode chambers 72 are filled with a counter-electrode electrolyte 74. The base medium and counter-electrode electrolytes are in ionic communication so as to electrically connect the capture material 40 in the capture slides 42 with the counter electrodes 70 in counter electrode chambers 72. The counter electrode chambers have side walls 76 that, when ready for use, are at least partially vertical over substantially their entire surface, so as to provide a continuous upward path for the escape of any gas bubbles (e.g., hydrogen or oxygen) generated by the action of electrode 70 on electrolyte 74. Advantageously, the electrolyte base medium 62 will be highly conductive, for example containing a universal purpose soluble anion and cation pair of from 0.001 to 1 molar concentration in aqueous solution. The universal purpose anion and cation pair may be substantially any soluble anion and cation pair that is compatible with the materials of comprising chambers 60 and 72, e.g., salts of sodium, lithium, calcium, or magnesium, and of chloride, fluoride, sulfate, thiocyanide and the like. One preferred salt comprising the pair is KC1 since the anion and cation have substantially identical diffusion coefficients, thereby minimizing any diffusion potential at an interface between any two electrolyte solutions having different concentrations of the electrolyte. In general, the universal purpose soluble anion and cation pair will not be either a weak acid or a weak base, since migration of the (more highly) charged form of either the acid or base at an interface between any two electrolyte solutions having different concentrations of the weak acid or base, or different conductivity, would cause a change in pH at, or across, the interface.

These electrolytes, however, may contain such weak acids or bases, judiciously selected and employed with a protocol to cause regulation or modification in electrolyte pH, as is described elsewhere herein. In a preferred embodiment, an acid-base pair may be employed advantageously as the universal purpose soluble anion and cation pair, without risk of a substantial pH change in the electrolyte when the pH of the electrolyte is substantially different from the pKₐ of either the weak acid or weak base. For example electrolytes containing ammonium acetate, ammonium formate, ammonium trifluoroacetic acid compositions may be employed advantageously in the neutral pH range (e.g., pH 5.0 to pH 8.0) since the pKₐ of these weak acids (acetate, formate, and trifluoracetic acid) are and weak bases (ammonium or alternatively an alkyl amine) are all substantially above below (for the acids) and above (for the bases) the neutral pH range. Preferably the pKₐ of the weak acids will be substantially below (and the pKₐ of the weak bases will be substantially above) the preselected neutral pH range of the electrolyte, i.e., at least by one pH unit. Preferably the pKₐ of the weak acids will be very substantially below (and the pKₐ of the weak bases will be very substantially above) the preselected neutral pH range of the electrolyte, i.e., at least by 1.5 pH units. For this reason, for example, trifluoracetate (lowest pKₐ) is preferred over formate, which is preferred over acetate (highest pKₐ), especially when the pH of the electrolyte is less than pH 6.0. Employing a weak acid, or weak base as the universal purpose anion and cation pair offers special advantage where the acid and base have a sufficient vapor pressure, at temperatures from 0 degrees centigrade to 100 degrees centigrade, that these species can be removed by vacuum pumping. Thereby the anions and cations may be employed as the electrolyte and then removed (thus eliminating an interference) prior to analysis of other captured analytes by mass spectrometry. Customarily such anions and cations will be employed in the concentration range from 1 millimolar to 1 molar as the universal purpose anion and cation pair.

Electrolyte base medium 62 may be provided as a gel, so as to increase its viscosity and prevent leakage, or trapping of air bubbles, by dissolving of gelling materials such as starch or agarose, or copolymerization of hydrophilic polymers, e.g., acrylamide or hydroxymethylmethacrylate, as is well-known to those skilled in the art. The one, or more, counter electrode chambers 72 may also be filled with electrolyte 74 having the same composition employed in electrolyte base chamber 60. Because chambers 72 are physically isolated from capture materials 40, however, much wider latitude in selection of conductive salts comprising the electrolyte 74 is possible. For example, high concentrations of inorganic salts (e.g., from 0.1 to 10 molar) and the general use of salts of either a weak acids or a weak bases, in order to provide for pH-buffering of the hydrogen or hydroxide ions produced by common counter electrodes 70, optionally may comprise counter-electrode electrolyte 74. Examples are 1.0 M pH 8.0 tris(hydroxymethyl) aminomethane-chloride (Tris) chloride, or 1.0 M, pH 9.2 potassium borate, or 1.0 M, 1.0 M, pH 7.0 imidazolium chloride, or the like, but virtually any suitable highly-buffered buffer solution would suffice, as well-known to those skilled in the art. In a preferred embodiment electrolyte 74 is comprised of a high concentration (e.g., 1.0 molar, or greater) of a salt that is neither a weak acid nor weak base, for example sodium or potassium (or the like), as the cation, and chloride, sulfate (or the like) as the anion. Although the pH of such an electrode chamber is relatively unbuffered, because of the high concentration of salts, only a small fraction of the total migrating charge will be carried by protons, hydroxyls, or proton-binding species. Thus the pH of any chamber connected to counter electrode chambers 72 either by diffusion, or electromigration, will remain relatively unaffected by pH changes in counter electrode chambers 72.

Electrolyte base chamber 60 of cartridge 2 may be pre-filled with a gelled counter-electrode buffer solution 74. For example, the gelled solution may be a 1% agarose gel, also comprising 1.0 M KCl, 1 mM histidine, pH 7.8. In a particularly preferred embodiment the gelled solution will be comprised of a weak acid or weak base having an appreciable vapor pressure at room temperature. For example a salt of trifluoracetate, formate, or acetate may be employed. Most preferably the gelled solution will comprise ammonium trifluoracetate having a concentration between the 1 millimolar and 1 molar. Most usually the concentration will be between 10 millimolar and 100 millimolar.

Also, in one embodiment the separation layer(s) 30 in cartridge gel plate(s) 32 and the porous capture materials 40 in the cartridge capture slide(s) 42, of cartridge 2 will be pre-filled with ionically conductive liquid media. For example the separation layer 30 may be polyacrylamide gel containing from 2% to 12%, or as much at 15% polyacrylamide polymerized in an electrolyte solution containing from 1 mM to 500 mM inorganic salts. In one embodiment the electrolyte pre-filled in the separation layer will be 50 mM KCl, 100 mM histidine, pH 7.8. The composition of the electrolyte pre-filled into the porous capture materials 40 in the cartridge capture slide(s) 42, of cartridge 2, may be of a wide variety of conductive salts dissolved in a solvent. The solvent may be an aqueous liquid, or another suitable organic solvent, such as methanol, ethanol, propanol, or the like, or alternatively acetonitrile or any other water-soluble organic solvent. Optimally the solvent employed will also contain from 1 to 1 M organic or inorganic salts to provide suitable electrical conductivity through the electrolyte. Conveniently, the same liquid electrolyte solution used to form the separation layer, e.g., 10 mM KCl, 100 mM histidine, pH 8.0 may be employed (or alternatively, a salt of trifluoracetate having a concentration between the 1 millimolar and 1 molar may be used).

Electronic instrumentation and control components are utilized together with disposable cartridge 2 to provide an analysis system. An adjustable +/−300V voltage source (i.e., with an adjustable range of 600 volts) can be used to provide the electrical field needed for electrophoresis. Such relatively low voltage sources are sufficient because the separation distance can be less than 1 centimeter, generally about 0.1 to 0.5 cm. Also, to monitor progress of separation and capture steps, current passing through each sample well 2 from sample electrode 20 to counter electrode 74 may be monitored separately. For example, 96 individual current meters may be used. Multiple current meters may be comprised of a single circuit for measuring current, but with a sample and hold circuit for reporting the current value (for example at a 1 Hz reporting frequency). In a preferred monde, the results are displayed graphically on a computer monitor. Alternatively an adjustable constant current source may be used in lieu of the voltage source. Usually the current source will supply from 0-100 milliamps per sample well. More usually, the current source will supply from 0-10 milliamps. Advantageously a computer controlled selectable, current source/voltage source may be employed. A preferred selectable source, and methods of its operations, are disclosed in U.S. application Ser. No. 11/636,412, filed Dec. 8, 2006, the specification of which is incorporated herein in its entirety by reference.

Alternatively the electronic components needed to carry out the subject invention may be even simpler and may, for example, include just a direct current voltage source and an array of sample electrodes. In this alternative embodiment, an adjustable +/−100-volt voltage source (usually <25 volts) may be used to provide the electrical field needed for electrophoresis. In a 25-sample analysis system, for example, 25 current meters are used, each with a sample and hold circuit for reporting the current value (at a 1 Hz reporting frequency). If desired, the results may be displayed graphically on a computer monitor. Alternatively, and even more simply, the electrophoresis may be performed with the voltage source alone, i.e., without monitoring current, but running the electrophoresis either for a predetermined time, or alternatively, until a detectable (visual, chemical, or electrical) end point is achieved.

Suitable apparatus for performing the method described below includes: a +/−100 V power supply; a 25-channel, individually adjustable, array of potentiometers; an Agilent model 34970A data acquisition/switch system; a 25-well Lexan cartridge; and a laptop computer. The software for the Agilent data acquisition/switch system may be configured to record voltage and current as a function of time for each of the 25 sample wells. An Applied Biosystems Voyager DF and 4700 model MALDI mass spectrometer may be used for mass analysis and quantification of analytes, including proteins and peptides.

### Describing Operation of the System:

1. A mixture of a fist and second groups of sample molecules are placed in a sample well 4;

2. Sample electrode 20 is brought in electrical communication with the sample in sample well 4;

3. The sample electrode 20 is energized with voltage source causing a faradaic reaction (i.e., and oxidation or reduction reaction) to occur in sample well 20 thereby causing an ionic current to pass from electrode 20, through sample well 2, through separation layer 30, through capture material 40, through electrolyte base medium 62, through counter electrode electrolyte in counter electrode chamber 72, and finally causing a faradaic oxidation or reduction reaction (opposite to that occurring at the sample electrode 20 in the sample well 4) to occur at counter electrode 70;

4. The ionic current results in an electric field that results in first charged sample molecules to become electrophoretically driven through the separation layer 30 and concentrated onto the capture material 40 located at the orifices 50 on cartridge capture slides 42;

5. Second sample molecules at the same time do not pass through the separation layer 30 either by consequence of having either no, or the opposite electrical charge as the first sample molecules, or alternatively by consequence of the second molecules to becoming lodged within, or otherwise retarded by, separation layer 30.

6. After capture of the first sample molecules onto cartridge capture slide 42, the slides are removed from the cartridge well frame 6;

7. The cartridge capture slide 42 then is washed with deionized water, or other suitable solvent, to remove salts and other substances that may interfere with analysis, such as mass spectrometry analysis;

8. A MALDI matrix solution is applied to the capture material(s) 40 on the capture slide(s) 42 and allowed to dry.

9. The capture slide having the dried MALDI matrix affixed to capture material 40 is inserted into a MALDI mass spectrometer and the mass of the first analyte(s) are analyzed via MALDI-MS. For example, the mean and standard deviation of each (m/z) peak height, or peak area may be determined as a function of the amount of sample material applied to sample well 4, or the source of the sample material applied (for example samples taken from a group of humans sharing a common characteristics, medical symptoms, or diagnosis). (Here m refers to mass and z to unit electrical charge.)

For example, in steps 8 and 9 during analysis of such prepared MALDI capture slides, small droplets of MALDI matrix dissolved in a suitable solvent are added to the analyte capture regions. The solvent is allowed to dissolve the analytes and, as the solvent evaporates, the analytes become incorporated within MALDI matrix crystals that form on the top surface of the capture membrane. After allowing time, usually for 1 minute to 60 minutes, for evaporation of the solvent liquid and formation of MALDI matrix crystals, the sample plate is ready for introduction into a MALDI mass spectrometer. Upon insertion of the MALDI sample plate into a mass spectrometer, the MALDI matrix crystals are illuminated with an intense UV laser light pulse resulting in ionization of a fraction of the analyte molecules, as is well known to those skilled in the art of MALDI-MS.

By way of further example, polyacrylamide may be used as the separation layer 30, in Step 5. When polyacrylamide is so used, the acrylamide or bis acrylamide contained in the polyacrylamide may be of sufficiently high concentration, crosslinking and thickness so that only molecules less than a selected molecular weight (or specifically, m/z) are allowed to pass through the separation layer. In the special case where the selected molecular weight is about 30,000 Daltons for proteins, i.e., the LMW fraction of proteins, the separation layer may be used to remove the highly abundant proteins, larger than 30,00 Daltons, from biological tissues including soft tissues, such as brain, muscle, liver, lung, pancreas, ovary, testes, and particularly blood plasma and serum. For serum, for example, the separation layer may remove albumin, IgG, IgA, hemoglobin, haptoglobin, antitrypsin and transferin, which normally comprise about 95% of the total mass of proteins in this modified tissue. Alternatively, a non-sieving gel, such as 1% agarose, may be incorporated in the cartridge gel plate 32 to carry out a separation without removal of the high molecular weight proteins. After capture of the one, or more analytes on the one, or more capture materials 40 of the cartridge capture slides 42 a MALDI matrix is applied to the capture materials 40 and the materials analyzed for the combined first and second molecules by MALDI-mass spectrometry as described previously.

A preferred embodiment of the invention has an array of sample wells 4, each having a top opening 8, side walls 10 bottom opening 14, and contained within the cartridge well frame 6. The preferred embodiment also has a corresponding array of sample electrodes 20 and an array of separation layers 30, one for each sample well. Preferably the array of separation layers 30 will be contained as an array in a cartridge gel plate 32 where the holes in the gel plate are spaced at appropriate pitch so as to align with the bottom openings 14 of the sample wells 4. After the analysis the slides 42 containing the array of one, or more capture materials 40 are achievable for re-examination or verification at a later date.

The cartridge capture slides 42 having an array of sample wells 4 may be present as a single capture slide, or as a stack of two, or more, cartridge capture slides stacked in series, where analytes pass serially through each capture material 40 present in the two, or more capture slides. When present as such a stack of two, or more, capture slides the capture material in each slide may be substantially identical, or alternatively, substantially different. Advantageously, the substantially different capture materials, in the successive serial capture slides may be used to fractionate different analytes into selected capture slides, as is described in more detail below.

As an example, the capture material 40 within capture slides 42 may be a single material, e.g., it may be made from porous poly(vinylidene difluorde (PVDF) obtained as Immobilon-P or Immobilon-P^{SQ} obtained from Millipore Corp., Billerica, Mass. (USA). The porous PVDF capture material may be attached to the capture slides 42 to form the capture layer 40 by either thermal, ultrasonic, or laser welding, as described in greater detail in U.S. application Ser. No. 10/963,336, filed Oct. 12, 2004. Also, advantageously, coating such membranes with a thin layer of conductive material prevents electrically charging of such PVDF membranes during analysis by MALDI-MS (Scherl et al., 2005, Gold Coating of Non-Conducting Membranes before Matrix-Assisted Laser Desorption/Ionization Tandem Mass Spectrometric Analysis Prevents Charging Effect, Rapid Commun. Mass Spectrom. 19: 605-10).

Fractionation of sample analytes may be increased further by increasing the number of successive layers of the capture slides 42 to two, or more, as shown in FIG. 2. In this embodiment the cartridge capture slides 42 are stacked so that analyte molecules sequentially pass through capture material 40 of each cartridge capture slide. Fractionation of molecules of PP within the successive capture materials of the capture slides 42 may be further improved considerably by employing capture materials 40 of substantially different chemical or physical surface properties in each of the two, or more, successive layers of capture slides 42 such that each will have a substantially different affinity for structurally different molecules of PP (i.e., proteins and polypeptides) in the sample.

In order to perform fractionation of sample proteins on multiple successive layers of capture slides 42, each capture slide may have a capture material 40 comprising a membrane. Thus in operation of the device, sample analytes, e.g., proteins or polypeptides, are electrophoretically driven sequentially through the two, or more, capture membranes. Advantageously, each capture membrane employed in sequence will have a substantially different affinity for different classes of analytes. Examples of such membranes with different affinities include PVDF, or other porous polymer, membranes coated with modifying materials, of lower molecular weight, that alter the affinity of the membrane for analytes. For example, hydrophobic membranes may be coated with graded concentrations of hydrophilic polymers and then performing a reaction step to irreversibly bind the hydrophilic polymers to the higher molecular weight membrane material. For example, porous PVDF membranes (e.g., Immobilon-P and Immobilon-P^{SQ} obtained from Millipore Corp., Billericia, Mass.) may be coated with different solutions, wherein each of the different solutions contains a different concentration of a neutral hydrophilic polymer. Examples of such lower molecular weight polymers include:

1. Polyethylene glycol (PEG), e.g., Fluka Cat. No. 94646, Mol. Wt. 35,000

2. Polyvinylpyrrolidone (PVP), e.g., Sigma Cat. No. PVP40T, Mol. Wt. 40,000

3. Polyvinyl alcohol (PVA), e.g., Sigma Cat. No. P8136, Mol. Wt. 30,000

Protocols for coating and irreversible binding of such low molecular weight polymers to such higher molecular weight polymeric membranes are well known in the prior art. An example of such a method is described in U.S. Pat. No. 6,354,443, which is incorporated herein by reference. The '443 patent method involves coating and irreversibly binding highly charged polymers, such as Nafion.RTM to PVDF membranes. This method employs baking of the coated membranes at a temperature below the melting temperature of PVDF to irreversibly bind the lower molecular weight polymers to the higher molecular weight PVDF. This method, although straightforward, leaves a substantial fraction of the coating polymer non-covalently-bound to the membrane. This loosely bound coating material subsequently suppresses analyte ionization during MALDI-MS analysis. Advantageously, a variety of chemical cross-linking reagents, such as glutaraldehyde, may be used to covalently bind the polymers to the membranes irreversibly. For example the cross-linking reagents may be hetero or homo-bifunctional cross-linking reagents, as is well known in the prior art.

After performing the coating and irreversible binding, procedures for electrophoretic mobility-based fractionation may be optimized. Experiments performed have shown that small highly charged peptides and proteins are captured first onto a PVDF-based capture membrane. By progressively extending the separation time (or, alternatively, increasing the applied voltage) progressively larger proteins are captured onto a PVDF-based capture membrane. These experiments also have demonstrated that some of the captured peptides can be eluted from the capture membrane with organic solvents (or MALDI matrix solutions containing organic solvents) and detected quantitatively by MALDI mass spectrometry. Also, successive fractions of proteins found in the serum samples can be captured onto the membrane targets. The fractionation procedure may be optimized as follows:

1. Apply a standard measured volume of a standard protein sample (for example as 2 μL standard human serum sample, or any other suitable standard mixture of one, or more proteins or polypeptides) by pipeting the same measured volume into each of the cartridge wells.

2. Apply an electrical field perpendicular to the plane of the membrane, or top surface of the capture material 40, by passing the current transversely though the membrane for a predetermined run time. For example a sufficient electrical voltage is applied so that a current density of 0.1 to 10 mA per sq. mm of membrane area passes through each well, for a run time in the range of from 5 to 120 minutes. During the time electrical field is applied, the current passing through each of sites containing the capture material 40 may be monitored or plotted to ensure uniformity and reproducibility in the electrical field in the capture material 40 present at different sites in an array of capture materials disposed upon a multi-well capture slide 42. The current passing through the membrane, or alternative porous capture materials, causes electro-concentration of charged sample analytes within the capture material.

3. Remove the capture slide(s) from the PPAS cartridge after the electro-concentration procedure is complete.

4. Wash the capture slide free of salts or other interfering substances.

5. Apply a MALDI matrix solution to the capture material(s) 40 on the capture slide(s) 42, thereby extracting the analytes from the capture materials, and allow to dry.

6. Insert the capture slide into a MALDI mass spectrometer and analyze via MALDI-MS. For example, the mean and standard deviation of each peak height may be determined as a function of the amount of serum sample used.

7. Perform optimization by repeating Step 1 through Step 6 at least two, or more times, each time varying either the current density, the run time, or both the current density and the run time. Generally the current density will be from 0.1 to 10 milliamp per square mm of membrane current density (or, more generally from 0.1 to 100 milliamps per square mm of apertures 50 in capture slides 42) and the run time will be between 5 and 120 minutes. The conditions (current density and run time) which give either the greatest number of protein or polypeptides peaks as detected by a mass spectrometer from the standard sample, or the greatest intensity for any one, or more, peaks are then adopted as the “standard optimized condition.”

The optimization method may be performed with biological samples, such as normal human serum (100 mL) purchased from Sigma Chemical Company, or an equivalent commercial source. Alternatively, such biological samples may be other biological fluids such as plasma, urine, cerebrospinal fluid, ascites fluid, saliva, or the like. Other suitable biological samples include lysed cells, either from biological tissues or obtained from cell culture. The optimization method may be repeated one, or more times sequentially while varying in sequence one, or more additional parameters; such as sample composition (e.g., pH and conductivity) and volume, electrolyte buffer composition, time, current density, capture materials, MALDI matrix solution composition or buffer or sample volume. The data obtained by MALDI-MS in the optimization method is analyzed and compared the results and the experimental parameters correlated so as to optimize the number and height of PP analyte peaks distinguished in the mass spectra.

In one embodiment of the above method, the current-voltage relationship during application of the electrical field in Step #2 is measured as a function of time. From the current-voltage relationship the change in resistance through the capture material 40 is calculated over time in order to determine when to terminate Step #2. For example, a time-course may be performed to capture fractions of different electrophoretic mobility on the array of capture membranes for discrete time periods encompassing 5-minute intervals from 5 minutes to 45 minutes. The resulting data are analyzed to determine the efficacy for time based LMW human serum fractionation. This time-based fractionation is then used as a protocol for analysis of serum peptides and proteins in selected ranges of molecular weights. The first fractions contain peptides of about 1-2,000 Daltons, successive fractions may contain peptides in the 2-5,5-10, 10-15, 15-25, 25-50, 50, 100, 100-200 and >200 thousand Dalton range. An associated standard operating protocol (SOP) for analysis of each molecular weight range may be selected such that a single sample may be analyzed for analytes in each of the molecular weight ranges and subsequently the spectra combined to provide for a complete proteome profile or for analysis of a selected molecular weight range.

Prior to performing the optimization and analysis the serum is divided into aliquots of from 10 microliters to 10 ml, e.g., 450 μL aliquots. If the analysis is not performed the same day, samples may be stored in a frozen state, for example stored at −80° degrees centigrade. By way of further example, the following experiments may be performed to demonstrate pH-based LMW serum sample fractionation with the PPAS. The sensitivity and reproducibility of the apparatus for detection of peptide/protein standards in sample buffer (and also with the standards spiked into normal human serum) may be examined at any selected pH value where the analytes are stable. For example the proteins and peptides conveniently may be analyzed at neutral pH, e.g., pH 7.0 to 7.5, as well as at pH values over a broader range, e.g., from 3 to 11. Suitable pH buffering species are selected to buffer in each one of the desired pH ranges. A wide variety of buffering species are found to be suitable because the capture membrane does not have appreciable ion-exchange properties. The buffering species may be either negatively or positively charged at the pH where the electrical field is applied to effect the separation of anion and cation analytes. The wash step (#4) advantageously is carried out by employing an ion exchange process to replace any bound buffering anions, i.e., a first anionic species, with washing anions, i.e., a second anionic species. Similarly, if cationic buffers are employed, the washing step (#4) is carried out by employing the ion exchange process to replace any bound buffering cations, i.e., a first cationic species, with washing cations, i.e., a second cationic species. In a preferred mode the washing anions are chosen advantageously to be a weak acid, where after binding a proton (and no longer electrically charged, i.e., neutral) have a sufficient vapor pressure, at temperatures from 0 degrees centigrade to 100 degrees centigrade, that the washing anions can be removed by vacuum pumping. Examples of such weak acids are trifluoracetate, formate, acetate, carbonate, etc. Correspondingly, washing cations are chosen advantageously to be weak bases, where after binding a proton (and no longer electrically charged, i.e., neutral) have a sufficient vapor pressure, at temperatures from 0 degrees centigrade to 100 degrees centigrade, that the washing cations can be removed by vacuum pumping. Examples of such weak bases are ammonia, alykylamines, etc. This selection offers a special advantage to subsequent substantial removal of the washing anion or washing cation.

Thereby in this method of washing, the washing anions and the washing cations may be employed in a first step to remove other anions or cations from analytes bound within capture material 40 by an ion-exchange process. Then in a second step comprised of vacuum-pumping the washing cations and anions are removed. The vacuum-pumping step consists of subjecting the capture material 40 to a pressure substantially below atmospheric pressure, e.g., less than 0.5 atmospheres, and more usually below 0.1 atmospheres. The washing anions or cations themselves can also be removed substantially, thereby allowing analysis of the analytes in a mass spectrometer with very little extraneous interference from electrolyte salts. Customarily the washing anions or washing cations will be contained within a washing solution in the concentration range from 1 millimolar to 10 molar. More usually the concentration of the washing anions or washing cations will be between 10 millimolar and 1 molar. Ampholyte molecules, e.g., histidine, glutamic acid, aspartic acid, serine, lystine, etc. may be employed as pH buffers. When doing so, however, in order to most effectively utilize the preferred washing method of a first ion-exchange step followed by a second vacuum-pumping step care, must be taken to perform the first washing step (comprising an ion exchange step) at a pH where the ampholyte and the washing ion (cation or anion) have the same electrical charge. For example washing anions (e.g., trifluoroacetate, formate or acetate) are employed below the isoelectric pH (pI) of histidine (i.e., pH 7.5) and washing cations (e.g., ammonium or alkyl amines) are employed above the isoelectric pH (pI) of histidine (pH 7.5). Optimal rates of ion exchange advantageously are encountered where a substantial fraction of the species to be exchanged is charged. For example for exchanging weak acids (anions) the pH will be at least 0.5 below the pKa of the acid. For exchanging weak bases (cations) the pH will be at least 0.5 above the pKa of the base. By performing the washing in the above-described manner, removal of electrolyte salts, in particular unbound buffer species, from the capture material 40, is carried out rapidly and effectively. Thereby the sensitivity of analyte detection on the capture material 40 by MALDI mass spectrometry will be increased.

For the purposes of a) instrument calibration, b) analyte quatitation, and general optimization of detection sensitivity, peptide/protein standards may be used, either as internal standards (i.e., added to samples containing unknown concentrations of analytes) or as external standards (i.e., analyzed separately from the samples). Examples of such standards include ubiquitin, gramicidin, cytochrome C, insulin oxidized B Chain and ACTH fragment (18-39). Additional suitable standard proteins may be added for each range of protein molecular weight applications to be covered by the PPAS. The sensitivity of detection for each of the standards in human serum (as defined as 3 times the standard deviation above the noise) may be determined. Approximately 20 PPAS cartridges may be analyzed to determine reproducibility of the system. Optimally half of the cartridges may be processed in the anion-capture mode (where negatively charged, i.e., anion, analytes, are electrophoretically driven from sample wells 4 and concentrated onto capture material 40) and the other half in the cation-capture mode (where positively charged, i.e., cation, analytes are electrophoretically driven from sample wells 4 and concentrated onto capture material 40). The generated optimized methods may be used to fractionate each of the samples into 5 or more analyte fractions concentrated onto capture material 40).

Alternative to using a preformed membrane material, such as PVDF, for the capture material 40, a substantially similar-functioning capture material may be cast into orifices 50 in the capture slides 42. For example, the capture material may be a hydrophobic, monolithic, porous polymer comprised of hydrophobic polymethacrylates including poly(butylmethacrylate), poly(methylmethacrylate) poly(ethylene-dimethacrylate) poly(benzylmethacrylate, or mixtures of these polymers, such as poly(butylmethacrylate-co-ethylene-dimethacrylate). Alternatively, the capture material may be made to be more hydrophilic. Examples of such (more hydrophilic) monolithic porous polymers include polymethacrylates such as poly(2-hydroxyethylmethacrylate), poly(glycidylmethacrylate), poly(diethylene glycol dimethacrylate), or mixtures, thereof. Alternatively, the capture material may be formed from a mixture of hydrophilic and hydrophobic polymers. Thereby advantageously the hydrophobicity the capture material 40 may be precisely selected from a range of hydrophobicities to have a predetermined hydrophobicity. The cast porous polymers comprising the capture material 40 may be deposited and attached to the sidewalls 56 of the orifices 50 in capture slides 42 according to a multiplicity of procedures well known to those skilled in the art. The procedures disclosed therein generally employ methacrylate monomers and also porogen solvents. In a preferred embodiment of manufacture of capture slides 42, the side walls 56 of the orifices 50 in the capture slides are first vinylized to enable covalent attachment of the porous monolith polymer to the walls 56. In the vinylization procedure the orifices 50 first are rinsed with acetone then with deionized water; activated with a 0.2 mol/L sodium hydroxide for 30 min, washed with water, followed by 0.2 mol/L HCl for 30 min; and finally, rinsed with ethanol. Next a methacrylate polymerization mixture comprising 20% solution of 3-(trimethoxysilyl)propyl methacrylate in 95% ethanol with its pH adjusted to 5 using acetic acid is flushed through the 1 mm deep monolith for 30 min. Following washing with ethanol and drying in a stream of nitrogen, the functionalized slides are left at room temperature for 24 hours. Next, the orifices are carefully filled with the methacrylate polymerization mixture.

In general, incorporation of hydrophobic monomers into the polymerization mixture permits hydrophobic monoliths to be manufactured. Similarly, selection of hydrophilic monomers allows hydrophilic monoliths to be manufactured. Also, mixtures of hydrophilic and hydrophobic monomers at a predetermined ratio may be employed to manufacture monoliths of a desired hydrophilicity or hydrophobicity. In any of these cases, a xenon lamp fitted with a water filter (to remove infrared radiation) may be used to initiate the polymerization in a polymerization step. While employing a xenon lamp of 150 watts, or greater, polymerization is completed after about 10 min of irradiation at a distance of about 10 cm. After polymerization, the solvent acting as a porogen in the polymerization mixture is washed away, for example by using a pressurized flow of methanol delivered with a syringe pump. Alternatively, porogens may be removed by simple diffusion into a rinse solution over a period of 12 hours, or more. Porous monolithic polymers, offer several advantages compared to polymers composed of small beads alone. For example, the monolithic polymers permit a significant increase the active surface area. Also, the monolithic polymers permit direct and covalent chemical-attachment of the capture material 40 to the walls of orifices 50. In a particularly preferred embodiment small polymer, glass, or ceramic beads from 10 microns to 200 microns in diameter, are added to the porous monolithic materials, prior to the polymerization step to produce “microlith” capture material 40. Such microliths mixtures are particularly advantageous because the mechanical strength of the capture material 40 is greatly increased by mixture of beads and porous the monolithic materials.

Subsequent to the steps of fractionation and capture, each of the layers in the cartridge capture slide 42 may be disassembled and analyzed separately in a mass spectrometer as described herein. The additional fractionation into the two, or more, capture layers provides both more information about the proteins (indicated by the nature of the affinity incorporated into each capture membrane) and also provides increased sensitivity of detection by MS (because each capture material has proportionately fewer PP total molecules and thus a greater fraction of substantially identical PP molecules may be incorporated into each capture material 40.

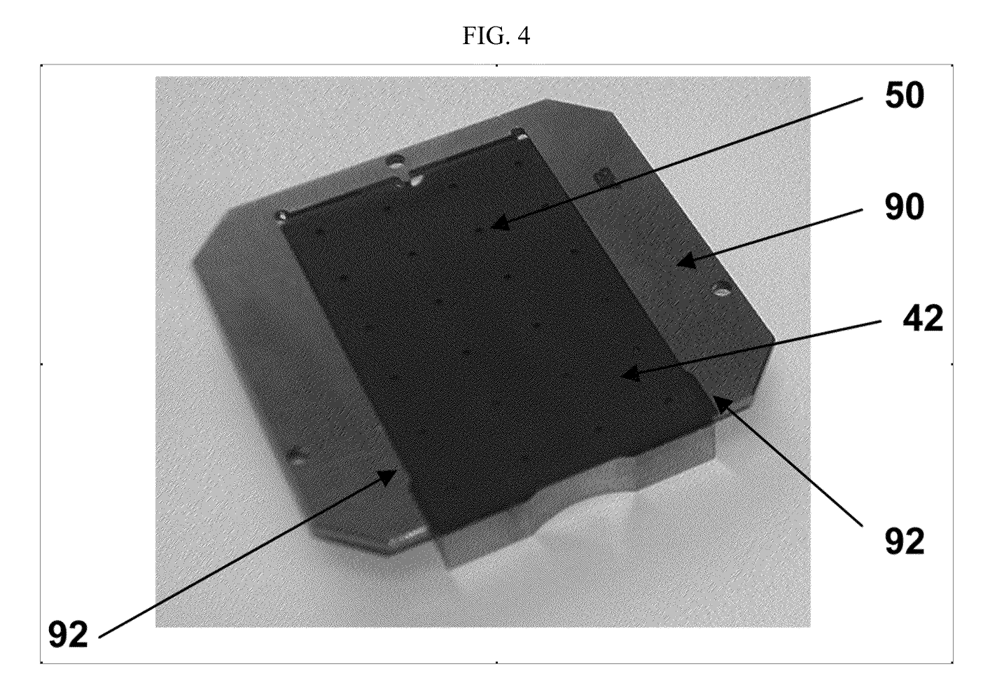

FIG. 4 shows a preferred embodiment of a cartridge capture slide that may be inserted directly into a standard slide holder 90 for an Applied Biosystems, Inc./Sciex Voyager DE MALDI TOF mass spectrometer. The cartridge capture slides 42 are made from a low electrical conductivity material so that greater than 90% of the electrophoretic current passes through the electrolyte in the apertures 50 also containing the capture material 40 in the cartridge capture slides 42. More usually the conductivity of the cartridge capture slides will be such that 75% to 99.999% of the current passes through the electrolyte within the apertures 50 (also containing the capture material 40 in the cartridge capture slides 42). In order to achieve this selected ratio of overall conductivities (i.e., determined by the geometry of components and the ratio of bulk, or surface conductivities of the slide and capture materials, compared to the electrolyte) during operation of the device, usually the volume resistivity of the material used to make the cartridge capture slides 42 will be between 10² and 10¹⁰ ohm-cm. More usually the volume resistivity of the cartridge capture slides 42 will be between 10⁴ and 10⁶ ohm-cm. This slight conductivity of the cartridge capture slides 42, however, is quite advantageous as it prevents charging of the capture slide 42 during ionization of the captured analytes in subsequent analysis by MALDI-MS. Also, advantageously the cartridge capture slide 42 is very flat, or alternatively may be designed to be flattened by insertion into a MALDI slide holder 90, such as that shown in FIG. 4, to +/−50 microns. This level of flatness helps to insure that the time of flight of identical molecules from the surface of the slide (that is irradiated with laser light energy) when in an electrical field, will hit the ion detector at substantially the same time (and thus will appear as a high-resolution peak in a MALDI-TOF spectrum).

The cartridge capture slide 42 may be attached to sample holder 90 by means of a mechanical guide 92, or alternatively by a ferromagnetic material, such as a magnet. For example, the magnet may be a small rare-earth magnet, e.g., a neodymium-iron-boron (NdFeB) magnet about 1 mm in thickness and about 2 mm in diameter. The ferromagnetic material functions to hold the lower component frame member (and the attached capture membrane) to a MALDI sample plate during MS analysis of sample analytes on the capture membrane. For this purpose, these magnets clamp with sufficient force to (#318 stainless steel).

In operation the PPAS device is used for preparation of samples to be relatively free of analytically interfering substances for subsequent analysis within a mass spectrometer. In such preliminary sample preparation in the PPAS device performed prior to mass spectrometry, electrically charged mobile analytes migrate within an electrolyte, and are electrophoretically driven by an applied electrical field from the sample well 4, which may be in an array of multiple sample wells, (e.g., disposed within a cartridge well frame 6) of an analysis system. Each sample well 4 serves to retain an electrolyte fluid comprising a sample containing one, or more sample analytes (e.g., PPs). Each sample well also serves to accept a sample electrode 20 that when inserted into the electrolyte fluid establishes electrical contact with the fluid and is able to apply an electrical current through the fluid. Thereby when a voltage is applied to the electrode 20 with respect to a common counter electrode 70, an ionic current flows through the fluid in well 4, comprising sample and a pH-buffered electrolyte diluting solution, thereby creating of an electric field in the sample well 4. The electric field results in electrophoretic movement and separation of the one, or more, analytes in the sample well 4. Advantageously, the apertures containing the capture material are substantially smaller in cross-sectional area than that of the sample wells 2, so as to provide for electrophoretic concentration of analytes within the capture material 40 within apertures 50. A preferred embodiment of the analysis system includes sample wells 4 that accommodate sample volumes of from 1 to 400 μL. The inside diameter of each well is approximately 6.7 mm at top opening 8 and narrows to approximately 1.0 mm at its bottom opening 14 so as to permit concentration of analyte molecules by electrophoresis into a narrower diameter aperture 50 containing a capture material 40 in capture slide 42. The wells narrow within a bottom portion 12 of the interior side walls 10 of the wells. Generally a side wall in such bottom portion 12 will have a slope between 20 and 30 degrees from the, generally vertical, center axis of wells 2. In a preferred embodiment the slope will be between 24 and 26 degrees from the center axis of wells 2. Generally, the diameter of the sample wells 2 will be between 5-20 mm and the capture region diameter between 10 microns and 1.5 mm.

Separating the bottom opening 14 of sample wells 2 from capture slide 42 is a thin separation layer 30. The separation layer may be comprised of sieving material (e.g., polyacrylamide gel) that is filled with electrolyte to maintain the two regions in ionically conductive and fluidic contact. The sieving material may be pre-cast and assembled, or cast in place, If cast in place, the polyacrylamide layer may be made by pouring liquid acrylamide monomer and cross-linker into the wells to any desired thickness. The liquid then is allowed to polymerize prior to assembly, for example either by incorporation of a free-radical chain-initiator such a ammonium persulfate, or by the addition of a photo-sensitizer, such as riboflavin, and illumination with light of a wavelength absorbed by the photo-sensitizer, e.g., either UV light or 400-450 nm light for riboflavin. Further, the separation layer 30 may be provided as, one or more, serially stackable sieving or separation layers. For, example, an agarose gel may be used in series combination with a porous polyacrylamide layer, a porous dialysis membrane, or both. When in such a series combination of two-or-more serially stackable sieving or separation layers are employed, the first element in the series, e.g., a porous agarose layer, advantageously acts a first pre-filter to keep the second element in the series, e.g., a polyacrylamide layer, from becoming overloaded with either sample analytes or interfering substances such as high abundance proteins. Optionally, a third element in the series, e.g., a dialysis membrane, may be used. When the third element is used, the second element, e.g., the polyacrylamide, in turn, acts as a second pre-filter filter to keep the third element, e.g., the dialysis membrane, from becoming clogged or overloaded with either sample analytes or interfering substances such as high abundance proteins during electrophoretic concentration. Alternatively improved anti-clogging characteristics of the polyacrylamide gel may be achieved alone by constructing the polyacrylamide to have a gradient in acrylamide concentration, a gradient in cross-linking, or both, as is well known to those skilled in the art of making such gradient gels. In this case the gradient gels will be arranged so that the analyte molecules enter the acrylamide on the side having a lower concentration of acrylamide, or less coss-linked acrylamide. In such a way clogging of the gel by highly-concentrated analytes, can be prevented.

Generally the capture material 40 will be contained in apertures 50 that pass transversely through cartridge capture slides 42. The charged analytes that pass through the separation layer, driven by electrophoresis, then are captured in the capture material 40 of an assembly on one, or more, cartridge capture slides (CCS) 42, the assembly constructed so that the orifices of successive cartridge capture slides align, coaxially, so that an analyte may pass sequentially through the porous capture material 40 in each aperture. Thereby such captured analytes are concentrated from a larger volume of the sample well 4 into a smaller volume in the capture material 40 retained in the capture slides 42. Also multiple analytes may be separated in a first separation step and subsequently captured in a second capture step. Such separation and capture steps may be performed by the capture materials in the successive cartridge capture slides, thereby substantially fractionating the analytes into different captured fractions. The assembly of cartridge capture slides 42 may comprise one, or more, sequential capture slides, usually from 1-10 such sequential slides, more usually from 1-5 sequential slides, but potentially from 1-100, or more, sequential slides as a series of stacked layers. The stack of sequential layers of capture slides 42 is constructed so that during operation ionic current is made to pass serially through each layer of slides 42 from a first sequential capture slide, then a second sequential capture slide, and so on until passing through the last sequential capture slide.

Advantageously, the capture material 40 in the apertures 50 of the capture slides may contain a modified capture material, where the modification increases the affinity of capture material 40 for selected analytes. Further such modified capture slides may be modified to have differential high affinity for different analytes. Still further, such modified capture slides with differential high affinity for different analytes may be stacked sequentially so that analytes encounter a first capture slide, then a second capture slide, then a third, and so one, each capture slide 42 having a capture material 40 with differential high affinity for different analytes. The first sequential capture slide 42 may have a high affinity for a first selected analyte. The second sequential capture slide 42 may have a high affinity for a second selected analyte. Further, capture material 40 in a third selected sequential capture slide 42 may be selected to have a high affinity for a third selected analyte, and so on, in sequence. Thereby the first, second and third, analytes may be captured specifically by the first, second and third sequential capture slides 42. Also thereby, fractionation of the first, second and third analytes into the sequential capture slides may be performed conveniently and rapidly.

The analytes having a high affinity for the selected capture slides for the may be predetermined. For example, any analyte that is a member of an analyte-anti-analyte binding pair, where a capture material 40 is modified by attachment of the anti-analyte, the capture material 40 of a predetermined capture slide 42 will result in specific capture of the predetermined analyte in the predetermined slide. For example, an analyte may have an antigenic epitope recognizable by an antibody such that immobilization of that specific antibody to the capture material 40 in a predetermined sequential capture slide 42 will result in specific capture of the predetermined analyte in the predetermined slide 42. In lieu of such an antibody, any complementary member of a binding pair may be utilized to bind the complementary analyte. Such complementary members herein are called ligand-receptor pairs. The affinity of binding of ligand to receptor may be selected to have a high affinity or low affinity. Different analytes may be captured selectively by sequential capture slides having different affinities for different analytes. Thereby fractionation of the analytes into the separate layers can be achieved.

Each capture material 40 is attached to a cartridge capture slide 42 comprising a rigid solid support thereby facilitating subsequent manipulations of the capture material including washing, drying, application of a MALDI matrix, a second drying step, and mass analysis in a MALDI mass spectrometer. Multiple capture materials, with the same, or different affinity for different analytes, thus can be inserted into the apertures 50 in multiple capture slides, stacked serially so that the apertures align, one with the other so that analytes pass sequentially through the different capture materials. For example, each of the slides may consist of a polypropylene frame having one, or more, small orifices with a porous polymer membrane, or monolith cast, welded, glued, or otherwise attached to each of the one, or more, orifices comprising capture regions.

The capture material 40 in the apertures 50 of capture slides 42 is porous and when filled with an electrolyte is in electrical (ionic) and fluidic communication with the top 44 and bottom 46 surfaces of the cartridge capture slide 42 and thus will carry electrical current through it. Electrical contact from the bottom surface of the capture slide 42 to a common counter electrode 70 is made through the electrolyte to a base medium 62 that also is comprised of an ionically-conductive (electrolyte) medium (such as an agarose gel) contained in electrolyte base chamber 60. The electrolyte base medium makes electrical contact with a common counter electrode 70 through a counter electrode electrolyte 74 contained in the counter electrode chamber 72 which houses the common counter electrode. The system is constructed so that when a selected voltage polarity is applied between a sample electrode 20 and the common counter electrode 70, an electrical current flows between the two electrodes. The current is carried by ionic species in the electrolytes disposed between the electrodes. Thus charged analyte present in the sample well are electrophoretically driven either towards electrode 20 or counter electrode 70. The analytes driven toward electrode 70 are concentrated in the capture material 40 present in the electrical path when a voltage of predetermined polarity is applied between sample electrode 20 and counter electrode 70. Applying the selected voltage polarity to two, or more of the sample electrodes, with respect to the opposing counter electrode causes analytes from the two, or more, of sample wells to be concentrated into two or more corresponding capture materials in a capture slide 42, separately, and simultaneously. The voltage applied to the sample wells may be selected to be of either positive or both negative polarity with respect to the counter electrode 70. Thus, either positively charged or negatively charged analytes may be concentrated into the separate capture materials, either individually, or simultaneously. Alternatively, the sample electrode polarity may be predetermined to be positive in one well and negative in another well, thus capturing negatively charged and positively charged analytes in two, or more different capture materials in a single capture slide 42 simultaneously. Thus in the analytical system 300, individual electrical circuits are thereby connected from the sample electrodes 20, through sample wells 4, through separation layers 30, through apertures 50 in the capture slide 42, through the electrolyte base chamber 60, through the counter electrode electrolyte 74 contained in the counter electrode chamber 72 and then finally to the common counter electrode 70.

Advantageously, the analysis steps used in operation of the PPAS device may include dissociation and separation steps that result in depletion of high abundance analyte molecules from low abundance analyte molecules. Such steps are useful for highly sensitive and reproducible analysis of peptides and proteins analytes by mass spectrometry. Such dissociation and separation steps may be performed more efficiently by employing the addition of a non-ionic or zwitterionic detergent or other suitable dissociating agent to samples present in the sample wells 4. For example, the detergent may be added in a suitable pH-buffered electrolyte prior to the step of applying a voltage. Alternatively, the detergent may be added either to the samples, or any other reagent present within the sample wells 4. The nonionic or zwitterionic detergent effectively dissociates hydrophobic peptides from large molecular weight, high abundance molecules such as albumin and IgG. Next, when a voltage (and resulting electrical current) is applied between the sample and the common counter electrodes analytes of selected charge in the sample are driven toward either the anode or the cathode (depending upon the sign of the applied voltage and the sign of the electrical charge on the analyte).

At any selected pH value of the sample, a binary separation of positively-charged and negatively-charge analytes may be performed. For example, operation at a sample pH of 7.8, and applying a positive voltage to sample electrode 20 with respect to the common counter electrode), will result in a positive current flowing from the sample electrode 20 to the common counter electrode 70. The positive current will cause positively charged analytes in the corresponding sample well 4 to migrate from well 4 and to be captured (on capture slide 42) in the capture material 40 present in the aperture 50 immediately below the corresponding well 4 (i.e., the device is said to be operated in the positive, or cation capture, mode). Conversely when a negative voltage is applied to the sample electrode, a negative current will flow from sample electrode 20 to the common counter electrode 70. The negative current will cause negatively-charged analytes in the sample to migrate from the sample well 4′, in which the analyte has been placed, and to be captured (on capture slide 42) within the capture material 40 present in the aperture 50 immediately below the corresponding well 4′ (i.e., the device is said to be operated in the negative, or anion capture, mode). In either negative (anion capture) or positive (cation capture) modes the current carried from each sample electrode will usually be from 10 microamperes to 10 milliamperes. More usually the current will be between 0.2 and 2.0 milliamperes. Proportionally more, or less, current may be employed in PPAS devices of proportionately larger, or proportionately smaller, respectively. Thus upon either reducing, or increasing the overall dimensions of the device 300, or particularly the dimensions of orifices 50, the current will either be reduced or increased, respectively.

Customarily, at least two sample wells are used for fractionation of any one sample. In one of the sample wells, the sample electrode is polarized positive and in the other negative with respect to a common counter electrode 70. The positive (cation capture) mode and the negative (anion capture) mode separations may be carried out simultaneously. In this case, separation of positively charged (cationic) and negatively charged (anionic) analytes then will occur simultaneously at a sample pH predetermined by the system operator. Thus fractionation (and capture) of sample analytes positively charged and negatively charged at the predetermined pH may be performed simultaneously. Further, separation of a single sample into two, or more, fractions of different isoelectric point is possible by employing sample buffer solutions in any two, or more, sample wells having two, or more, different pH values. Thereby fractionation, concentration, and capture of analytes according to isoelectric point may be accomplished. Detailed methods for further fractionation by molecular charge at preselected electrolyte pH values are disclosed below in further embodiments of the invention.

In addition to charge-based fractionation according to isoelectric point, a sieving material optionally may be employed in the separation layer between the sample and the capture material. Analytes that are electrophoretically driven from a sample well 4 towards a corresponding capture material 40 advantageously pass first through the sieving separation layer 30. The sieving layer thus serves to provide for additional fractionation by retarding the migration of high molecular wt. analytes with a given m/z value with respect to lower molecular wt. analytes with the same m/z values, as is well know to those skilled in the art of gel electrophoresis. (Here m represents the mass of a molecule and z represents the charge on the molecule under the defined experimental conditions, e.g., pH, temperature, etc.) For example, under conditions where a detergent (e.g., sodium dodecylsulfate, i.e., SDS) is present to bind to the proteins roughly in proportion to molecular weight and thus give all proteins a similar m/z value, the migration time of proteins through a polyacrylamide gel is well known to be approximately proportional to the logarithm of molecular weight of the proteins. Thereby the sieving material may be used to isolate the LMW proteome fraction when the value of m/z is similar for proteins of different molecular size. A sieving material, such as a polyacrylamide gel, may be utilized without a charged detergent such as SDS. This type of separation is also well known in the prior art and is often referred to as a “native gel” separation. In such separation by sieving, the time of application of the predetermined voltage, or current, is chosen to provide for optimal separation of proteins in any predetermined range of molecular weight. Lower molecular weight (i.e., higher mobility) analytes will pass through the sieving layer more quickly and thus will be captured on the capture materials 40 prior to the lower mobility analytes. Thus the PPAS device disclosed herein may perform a kinetic separation. Thereby high mobility analytes either may be concentrated into a single capture material or a further separation may be performed in combination, by passing a fraction of the analytes through a series of two, or more, stackable capture slides, where each of the two or more slides have at least one aperture 50 coaxially aligned with other apertures 50 of an adjacent capture slide 42. Also, in sequence, each aperture may have a different predetermined capture material 40, thereby performing separation of analytes based upon affinity and thereby providing for maximal fractionation with a minimum number of capture slides. For example the different capture materials may comprise a difference in hydrophobicity of the capture materials. By way of further example, the top capture material (i.e., that present in the capture slide 42 positioned closest to the sample well 4) may be the least hydrophobic and the capture material sequentially farthest from the sample well may be the most hydrophobic. Thereby a gradient of hydrophobicity is created in order to provide for separation and analysis of analytes according to their hydrophobicity. By employing such sequential slides having different capture materials 40 with different hydrophobicity, or other affinity for analytes, then when the system is operated in combination with a sieving separation layer 30, both molecular weight and affinity separations may be performed in combination and simultaneously. Since a multiplicity of two, or more, samples may be separated independently and simultaneously within cartridge 2, multiple such samples may be separated, both by molecular weight and affinity, in combination and substantially simultaneously. Performing such a multiplicity of separations in a multiplicity of separation modes simultaneously (not only) both increases the effectiveness of separation of each sample, but also increases the number of such samples separations that may be performed per unit time (i.e., increases sample throughput).

Advantageously the fractionation and capture steps can be carried out relatively quickly provided that the separation and capture layers are relatively thin. For this purpose the separation and capture layers usually will be between 20 microns and 20 mm in thickness. More usually the separation and capture layers will be between 200 microns and 5 mm in thickness. For such thin separation and capture layers, the fractionation steps may take from 10 seconds to 100 minutes. Customarily the separation and capture will occur in less than 1 hour. More usually the separation and capture will be performed in between approximately 1 minute and approximately 60 minutes. After the capture step, the PPAS device is disassembled (as shown for example in FIG. 3) and each of the cartridge capture slides is washed (during a brief wash period of approximately from 1 to 60 minutes) to remove salts or other chemical species that interfere with detection by MALDI or electrospray mass spectrometry. For example the capture slides simply may be rinsed in deionized water. (In a particularly preferred mode, however, the ion exchange and vacuum drying process described in detail elsewhere in this disclosure will be used.) After the washing step, a MALDI matrix solution is applied to each of the capture regions of each capture slide and matrix allowed to dry. After the drying step, the slides are directly inserted into a mass spectrometer (e.g., a MALDI-TOF MS) for mass analysis of the captured analytes. Alternative, to detection of captured analytes directly from the capture material 40 in a mass spectrometer, the analytes may first be eluted from the capture material and detected by any variety of means, including MALDI-MS or electrospray-mass spectroscopy. Prior to analysis, the analytes may be reacted, or digested to provide a further increase in either the sensitivity of detection, or the specificity for identification of a particular analyte detected. For example, proteolytic digestion by enzymes, e.g., trypsin, and analysis of the resulting peptide fragments, i.e., by constructing a “peptide map” may be employed to identify captured protein molecules. Alternatively protein analytes may first be reacted to provide fluorescent labels on the proteins and the fluorescence detected directly by a fluorescence detector, as well known in the prior art. Also, specific antibodies, or other ligands having an attached label may be employed to specifically identify a bound analyte molecule, where the label is subsequently detected either directly by examination of the capture material 40, or alternatively after extraction of the capture material 40 into an extraction solution, and subsequent analysis of the extraction solution for the label, as is well known to those skilled in the art of operation of such labeled assays. Alternatively any other analysis means known to those skilled in the art of protein identification and analysis may be utilized to determine the presence of (and quantity of) bound proteins.

The cartridge capture slides may be molded by injection (i.e., “injection-molded”) from carbon-doped (or doped with other types of conductive material) polymers, (e.g., polypropylene). The added conductivity of the polymer permits direct analysis in a MALDI-TOF mass spectrometer without charge spreading. The capture material 40 may be formed from a hydrophobic membrane such as polyvinylidine difluoride (PVDF) attached to the capture slide 42 by any suitable means, for example by using an adhesive, or by welding through application of a solvent or heat to either the capture material, the slide, or both. Alternatively the capture material may be cast into orifices 50 in the capture slides 42. In a particularly preferred embodiment, the capture material is comprised of porous poly(butyl methacrylate-co-ethylene dimethacrylate) polymer monoliths. Such monoliths may be cast by polymerization according to methods well known to those skilled in the art. For strong and robust capture slides 42 having tightly bound capture material 40, the internal wall surfaces of the slide orifices 50 are first vinylized to enable covalent attachment of the monolith capture material 40 to the walls of the orifices 50. For example, during manufacture, the orifices 50 in capture slides 42 first are rinsed with acetone and water; activated with a 0.2 mol/L sodium hydroxide for 30 minutes, washed briefly with deionized water, followed by 0.2 mol/L HCl for 30 min; and then finally, rinsed briefly with ethanol. A 20% solution of 3-(trimethoxysilyl) propyl methacrylate in 95% ethanol, pH 5 (for example ethanol with to 0.1 to 1.0% acetic acid) is flushed through an approximately 1 mm thickness monolith for about 30 min. Following washing with ethanol and drying in a stream of nitrogen, the functionalized slides 42 may be left at room temperature for about 24 hours. The choice of monomer capture material 40 permits selection of the capture material hydrophilicity. Next, the orifices 50 are either filled, or overfilled with, for example, the methacrylate polymerization mixture, covered to prevent evaporation and allowed to polymerize. Standardly, a Xenon lamp (50 to 500 watts) is fitted with a water filter is used to initiate photopolymerization. Polymerization is completed after about 10 min of irradiation at a distance of about 10 cm. When the orifices 50 are overfilled, the excess material is subsequently trimmed away, for example by a sharp razor blade. The resulting monoliths (or microliths when from 5% to 50%, v/v, of polymer, glass or ceramic beads are included in the polymeriation mixture) then are washed for about 12 hours either in a methanol bath, or by using methanol delivered by a syringe pump, or any other suitable means of providing a relatively slow and continuous flow. Porous monolithic or microlithic polymer compositions, permit a significant increase the active surface area available for capture of analytes (compared to capture materials composed solely of beads or other particles). As disclosed more fully below, mixtures of such porous monolithic polymers together with chromatography particles, e.g., porous glass beads, are used as a preferred capture material 40.

For analysis of the sample analytes captured on the capture materials 40 by MALDI-MS a MALDI matrix first is dissolved in a suitable solvent and is added to the capture materials 40 exposed on the top surface 41 of capture slide 42. Preferably the solvent is dispensed as small droplets (e.g., in a total volume of from 0.1 to 1.0 microliters). The solvent containing the matrix when applied to the capture material 40 dissolves the bound analytes of interest. Then as the solvent evaporates, the analytes become incorporated into MALDI matrix crystals that form on the top surface 41 of the capture slides specifically at the sites of the capture materials 40. After allowing time for evaporation of the solvent liquid and formation of the MALDI matrix crystals, the capture slide 42 is ready for introduction into a MALDI mass spectrometer. As an example, FIG. 4 shows the cartridge capture slide and a holder that permits its direct insertion into a standard Applied Biosystems, Inc./Sciex Voyager DE MALDI-TOF mass spectrometer slide holder. Upon insertion of the MALDI capture slide 42 into a mass spectrometer, the MALDI matrix crystals are illuminated with an intense laser light pulse (e.g., a pulsed UV laser such as a nitrogen laser) resulting in ionization of a fraction of the analyte molecules, as is well known to those skilled in the art of MALDI mass spectrometry.

Removal of Interfering Chemical Species from Capture Slides by Selective Washing Compositions and Methods

Prior to addition of a MALDI matrix or insertion into a mass spectrometer the capture slides may be washed in a washing step to remove nonanalyte materials that interfere with detection and quantitation of the bound analytes. Such washing step is carried out after capture of an analyte on capture material 40 retained within apertures 50 of capture slides 42, and after the capture slide is removed by disassembly of cartridge 2. During the washing step extraneous salts and inorganic, or organic, pH-buffering species are washed free of the capture slide and capture material 40 retained within the apertures 50 of the slides 42. The washing compositions and methods are carefully chosen to retain the analytes of interest on the capture material during the washing process. For example, such selective washing of hydrophobic capture materials 40 may be performed in such a way as to retain PP analytes, i.e., proteins and peptides. Customarily such a washing step will utilize substantially aqueous solvents. Washing may be done, by a) diffusion, pressure-driven flow, electrophoresis (i.e., removal of electrically-charged interferants), or alternatively by electro-endosmosis, or by a combination of any two, or more, such methods.

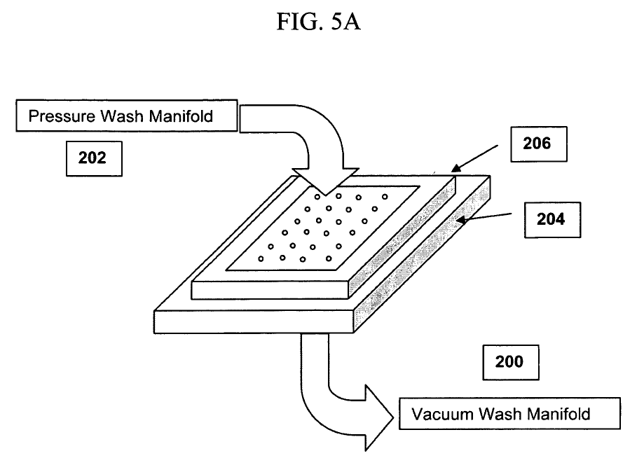

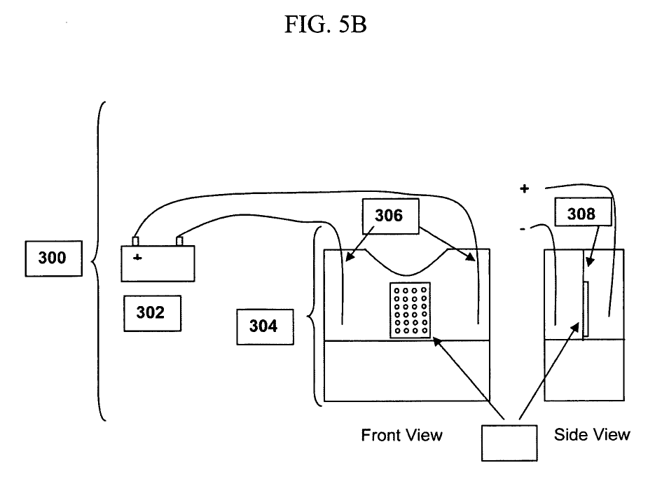

For example, pressure-driven flow of wash solution may be effected by a device, such as that shown in FIG. 5A designed to apply a differential pressure across the capture slide 42. Such a pressure differential may be applied, for example by applying a vacuum with a vacuum manifold 200 to one side of the slide causing fluid from a fluid bath on the opposite side to flow through the capture material 40 in the slide toward the vacuum manifold 200. Alternatively a positive pressure may be applied by means of a positive pressure manifold 202 to the side of the slide having the fluid bath, thereby also effecting substantially a pressure-driven flow of the washing fluid across the capture material. In either case, capture slide 42 is supported by a pressure-retaining support 204 working in conjunction with a slide sealing means 206, such as a rubber, or soft polymeric gasket, or “O-rings” to provide for sealing. Advantageously the vacuum or positive pressure may be used to apply fluid flow substantially simultaneously, across a multiplicity of two, or more, capture materials 40 within two, or more, apertures 50 within a capture slide 42. A fluid that may be used for the washing procedure, for example, can be deionized water (DI) or alternatively a “MALDI-friendly” ion-containing aqueous solution such as 0.1% trifluoracetic acid (TFA) in DI to purge the interfering salt from the capture material 40 while retaining desired PP analytes bound to the capture material. Such “MALDI-friendly” ions characteristically are those ions when converted into a neutral (i.e., uncharged) species by loss, or gain of a proton, have an appreciable vapor pressure and can be “pumped off” rapidly in the vacuum chamber of a mass spectrometer, or other suitable vacuum source. Examples of such “MALDI friendly” materials, that are ionic at selected pH values, are acetic acid, formic acid, propionic acid, butyric acid, ammonia, piperizine, pyridine etc., as is well known to those skilled in the art of preparing samples for MALDI-mass spectrometry. The vacuum pumping step for removing of acidic species such as acetic acid, trifluoracetic acid, formic acid, and propionic acid advantageously can be accelerated by reduction of the pH. Correspondingly the vacuum-pumping step for removing of basic species such as ammonia, piperizine, pyridine etc., advantageously can be accelerated by increasing the pH. Particularly preferred are combinations of these washing “MALDI-friendly” ions as ion pairs. Examples of such ion pairs are ammonium acetate, ammonium formate, ammonium trifluoroacetate, etc. The combinations of ammonium acetate, ammonium formate, ammonium trifluoroacetate, etc. customarily are employed and vacuum-pumped at neutral pH (e.g., usually at a pH between 4.0 to 10.0, and more usually at a pH between 5.0 and 9.0).

Alternatively, as shown in FIG. 5B, an electrophoretic device 300 may be employed to apply an electric field across capture material 40 in slide 42. The electrophoretic device comprises voltage source 302, a fluid reservoir and slide holder 304 having an electrode pair 306 to serve as an anode and cathode, and a septum 308 acting to isolate the anode from the cathode so that current must pass through the apertures 50 within capture slides 42.

For most effective electrophoretic washing of capture materials on capture slides free of inorganic salts and inorganic and organic pH buffering species, the following principles and procedures are used, either singly, or in combination:

### A. Hydrophobic Ion Exchange:

A first ion-exchange step is used to exchange MALDI-unfriendly interfering species for “MALDI-friendly” ions, which will have an appreciable vapor pressure, especially when the pH is adjusted subsequently, as discussed above. When the capture materials on capture slides have an affinity for hydrophobic ions, e.g., the capture materials 40 have “reversed phase” chromatography properties, hydrophobic interfering species will be bound to the capture materials as well. Accordingly in the first washing step, such hydrophobic interfering species are exchanged for hydrophobic ions of like charge, (i.e., either positively charged, or negatively-charged species). For example when histidine buffer (isoelectric point 7.8) is employed, (zwitterionic histidine is extremely “MALDI-unfriendly” in that it dramatically suppresses ionization of protein or peptide molecules in usual MALDI matrix solutions such as CHCA or sinapinic acid) the histidine advantageously is exchanged for negatively charged trifluoractetate ions at a pH where histidine is negatively charged, i.e., at a pH above 7.8. For example, 0.1 M ammonium trifluoracetate at pH 8.5 may be used to perform the ion-exchange step. Usually concentrations between 1 millimolar and 1 M of the washing ions are employed. Alternatively, histidine at a pH less than its isoelctric point (where it is positively-charged) can be exchanged for positively-charged pyridinium, ammonium, or the like ions (cations) and performing a washing step at a pH below its isoelectric point of 7.8. For this purpose a 1-millimolar solution of pyridinium or ammonium chloride here both at pH 4.0, for example may be employed. Subsequently in a second step the free pyridinium or ammonium chloride is washed away in a brief rinse in either water (e.g., distilled or deionized water) or a dilute “MALDI-friendly salt such as 1 millimolar (ammonium or pyridinium) trifluoracetate, (ammonium or pyridinium) formate, or (ammonium or pyridinium) acetate. Then in a final 3^{rd} d step, the ammonium or pyridinium salts may be removed by pumping in a vacuum.

Similarly, other negatively charged interfering species, such as the buffering species HEPES, TES, HEPPS, CAPS, CHES, ACES, ADA, BES, MES, MOPS PIPES can be removed by similarly exchanging these negatively charged ions (anions) for the anioic forms of trifluoracetic, formic, or acetic acid (advantageously employed either as the dilute acid, or as ammonium salts) in a first ion-exchange step. A second vacuum-pumping step then may be employed to remove the trifluoracetic, formic, or acetic acids or their ammonium salts, for example.

By symmetry, positively charged interfering species, such as the buffering species Tris, ethanolamine, creatinine, etc. can be removed by performing the washing in the following steps where in a first step these positively charged hydrophobic ions (cations) are exchanged for cations that may be removed by a vacuum. For example a first such ion-exchange step may be carried out in 1-100 millimolar ammonium chloride. A second rinsing step is employed to rinse away any excess ammonium chloride. For example distilled water or a 1 mM solution of ammonium trifluoracetate, trifluoracetic acid, etc., may be employed. The in a third step the ammonia, and/or trifluoracetic acetate ions are removed by vacuum-pumping step. (The second rinsing step is optional, but serves to speed up the third pumping step.)

### B) Washing by High-Field Electrophoresis:

An electric field advantageously optionally may be used to speed up the rate of washing. The high-field washing method employs a first step where the conductivity of the electrolyte is reduced by substantial dilution, for example in distilled water. Then in a second step a high electrical field is applied across the capture material 40 in capture slides 42). Customarily the applied voltage will be between 50 volts and 15,000 volts. More usually the applied voltage will be between 100 volts and 5000 volts. In this method the loosely bound hydrophobic buffer ions dissociate from the capture material 40 and are swept out by the high electrical field before they can rebind. In this method, the pH will be in the 3-11 range, and more usually for optimal performance, will be in the 4-10 range, so as to keep the conductivity relatively low. The low conductivity is required so as to apply a high electrical field without producing an excessively large current. With the devices disclosed above, currents above 1 milliamp per well may cause excessive Joule heating within the apertures 50 of capture slides 42. Such Joule heating is known to be proportional to the square of the current, i.e., proportional to I²R, where I indicates the current and R the resistance through apertures 50).

### C. Electro-Endosmotic (EEO) Flow

Flow generated by EEO is proportional to the electrical field across the capture material 40, and also is a function of the zeta potential, i.e., the potential drop across the plane of shear from the solid phase capture material 40 (e.g., membranes, monoliths, or microliths) to the liquid electrolyte on the surface of the capture materials. As charged hydrophobic species are washed free of the capture materials 40, the zeta potential is diminished. The EEO flow thus will be diminished as the washing step is completed. A high electrical field is optimal for high EEO, thus substantially the same conditions optimal for High-Field Electrophoresis mentioned above are optimal for EEO flow.

### D. Coulombic Repulsion

In this simple method capture slides 42 are place into a dilute electrolyte, such as distilled, or deionized water at a pH where the bound buffer ions are charged. Coulombic repulsion of the ions pushes them out of the microliths. In order to carry out the coulombic repulsion method optimally, the ionic strength of the wash solution advantageously is kept low, i.e., under a concentration of 1 millimolar dissolved ions. Also any hydrophobic species that might ion pair with the interfering ionic species to be washed free of the capture material are to be avoided.

### Example Electrophoretic Washing Procedure:

To remove interfering hydrophobic anions, e.g., ACES, HEPES, PIPES, etc., from capture materials 40 the following steps are carried out:

1. A wash solution of 0.1% trifluoracetic acid (TFA) is used to supply 1 milliamp per square mm of aperture area through apertures in the capture slides for 5 minutes. This will accomplish ion exchange.

2. After carrying out step #1, the capture slides are rinsed with DI water, or equivalent in order to remove any excess TFA. For example the wash solution employed in step #1 may be diluted approximately 1/100 with distilled, or deionized water.

To remove interfering hydrophobic cations, e.g., trihydroxy-amino methane (“tris”) creatinine, etc., from capture materials 40 the following steps are carried out:

1. A wash solution of 0.1% ammonia is used to supply 1 milliamp per square mm of aperture area through apertures in the capture slides for 5 minutes. This will accomplish ion exchange.

2. After carrying out step #1, the capture slides are rinsed with DI water, or equivalent in order to remove any excess ammonia. For example the wash solution employed in step #1 may be diluted approximately 1/100 with distilled, or deionized water.

Following the electrophoretic washing steps described above the capture slides are placed in a vacuum in order to completely remove any remaining TFA or ammonia, or other such material having an appreciable vapor pressure at room temperature.

Trans-elution of Captured Analytes from Cartridge Capture Slides and MALDI Matrix Addition for Analysis by MALDI Mass Spectrometry

Once analytes have been concentrated and captured onto the capture materials 40 retained with apertures 50 of cartridge capture slides 42, and potential interfering species removed, captured analytes then may be analyzed. For example, analysis by MALDI-TOF mass spectroscopy may be performed. Standard MALDI-MS matrix compositions and methods may be used to dissolve and thereby extract captured proteins and deposit them within MALDI matrix crystals for analysis in a MALDI mass spectrometer. Such standard procedures are well known in the field of mass spectrometry and have been well documented in the literature.

An example standard MALDI matrix and procedure for extraction and deposition of analytes contained within capture material 40 within a cartridge capture slide 42, so as to dispose the analytes within MALDI matrix crystals on the top surface 41 of the slide is to employ a matrix solution consisting of a mixture of 1 part of 20 mg/ml sinapinic acid in acetonitrile and 1 part 0.1% (v/v) trifluoroacetic acid in water (i.e., the final concentration of sinapinic acid is 10 mg/ml). A volume of 0.25 microliters of the mixture of matrix solution is carefully added to the top surface 41 of the sample slide 42 at the site of each capture material 40. Usually relatively small volumes of from 0.01 to 2.0 microliters are employed so that the majority of the solution remains on the material (rather than spreading to the surrounding slide material). More usually volumes of 0.1 to 0.5 microliters of matrix solution are employed. After drying in air, a second similar volume addition of the matrix solution is applied in the same manner. Optimally, the same volume (in this case 0.25 microliters) is used for the second addition. The cartridge capture slide 42 then is again dried, either by drying in air, or by means of a vacuum applied within a desiccator. After removal of the acetonitrile/water solvent, MALDI-MS measurements and analysis may be performed in a MALDI-mass spectrometery. Conveniently the capture slide 42 is inserted into a slide holder 90 having a mechanical guide 92 for retaining the slide. An example of such a slide holder adapted for use in Applied Biosystems Voyager MALDI mass spectrometers is show in FIG. 4. In such analysis by such a method optimal results are obtained by applying the MALDI matrix solution to the capture material exposed at the top surface 41 of the capture slide 42. Subsequently, the top surface 41 of slide 42 also is positioned in the sample holder of a mass spectrometer, so that within the MALDI-mass spectrometer the same surface, 41, of the capture slide is probed with the laser beam of the MALDI-mass spectrometer, and therefore the analyte ions to be detected are emitted from the top surface 41 of the capture slide, accelerated by the electric field within the mass spectrometer, and finally detected by the ionic current detector with the mass spectrometer, a process that is well known to those skilled in the art of MALDI mass spectrometry.

In a preferred alternative analysis procedure, advantageously an analyte elution solvent is first applied to the bottom surface 43 of the sample slide 42 (i.e., to the surface positioned within cartridge 2 opposite that of the sample well 4). By this procedure analyte molecules are eluted from the capture material and concentrated at the top surface 41 of the capture slide prior to formation of (and incorporation of analyte molecules within) MALDI matrix crystals at the top surface 41 of the capture slide. This procedure makes the analyte elution process more sensitive, decreases the analytical variation, and makes the analysis less dependent upon the depth within the capture material where an analyte is captured. The MALDI matrix may be applied, either to the bottom surface 43 of slide 42 together with the elution solvent, or alternatively to the top surface 41 after the analyte elution process is complete.

An example analysis method is as follows:

1. A sample, or plurality of samples, is placed into sample wells 4 of cartridge 2.

2. A predetermined voltage, a predetermined current, or a predetermined amount of electrical power, is applied to each sample wells by sample electrodes 20.

3. Analyte molecules having a predetermined electrical charge (i.e., either anions or cations) are electrophoretically separated from other analytes though separation layer 30 and are concentrated and captured though the top surface 41 of a capture slide 42 at sites having a porous capture material 40.

4. The cartridge is disassembled so as to gain access to the capture slide 42.

5. A washing procedure is performed to remove interfering species.

6. Analytes are eluted from the porous capture material 40 to an analysis side of the capture slide, which in a preferred mode is the top surface 41, by applying a MALDI matrix solution to the porous capture material 40 of capture slide 42 on either the top side 41 or the bottom side 43 of the capture slide, which in the preferred embodiment is the top surface 41.

7. The MALDI matrix is dried in air, other dry gas, or a vacuum, and the capture slide is then inserted into a MALDI mass spectrometer for analysis so the analysis surface is exposed to the laser beam probe and the ion detector of a mass spectrometer. In the preferred embodiment of the invention the top surface 41 of the capture slide is so exposed.

8. Analytes captured onto the capture slides are analysed for their mass, (more precisely their m/z value) and their relative abundance.

In an alternative procedure mode step #6 above is carried out as follows:

The cartridge capture slide is inverted over a drying apparatus (such as a 1-10 cm/sec air velocity fan) and a solution of acetonitrile and deionized H₂O (typically 9:1 v/v) is applied to the capture material 40 exposed at bottom surface 43 of each capture slide 42. After allowing a few minutes for the elution solvent to be drawn through the porous capture material, this step is followed by a second elution step that includes MALDI matrix, e.g., concentrated sinapinic acid (e.g., 9.0-90 mM in deionized water, pH 7.0-8.0) in methanol (typically also 9:1: v/v). This step is followed by a third elution step wherein the pH is adjusted to be acidic (typically 9 parts of acetonitrile and 1 part of 0.1% trifluoracetic acid in deionized H₂O. To ensure that the MALDI matrix (e.g., sinapinic acid) is completely dry and well crystallized a drying means (e.g., applying a vacuum within in a desicator) is employed. After sufficient drying, MALDI-MS measurements and analyses are performed in a MALI-mass spectrometer such as a Bruker Autoflex model, or an Applied Biosystems Voyager model, for example. This method of MALDI matrix addition also provides for the elution of biomolecules to the top surface 41 of the slide 42, further reducing the limits of detection of analyte molecules in such MALDI-MS measurements.

Preferred Cartridge Capture Slide Configurations, Capture Materials and their Method of Manufacture

Cartridge capture slides 42, has apertures 50, and capture materials 40 residing within the orifices. In a preferred embodiment the capture slide has 96 apertures, disposed in a 8×12 rectangular array (i.e., 12 columns and 8 rows) wherein the center of each aperture is spaced apart 9.00 mm from each of the closest four neighboring apertures (i.e., has a 9.00 mm pitch). Usually the apertures 50 will be between 0.1 and 5 mm in width and also between 0.1 and 5 mm in depth. In the preferred embodiment, the apertures 50 are approximately 1.0 mm in diameter and approximately 1 mm in depth. In manufacture, the generally flat capture slide, with very small variation in thickness (typically less than ca. +/−50 mm), has orifices that are formed by machining, (for example by laser, or mechanical drilling) molding, or casting, as is well known to those skilled in the art of polymer device manufacture. In a preferred embodiment, the capture slide material is selected to optimize the bulk and surface conductivity. As mentioned previously, the conductivity of the cartridge capture slides 42 will be such that at least 90% (more generally from 75% to 99.999%) of the current applied to the capture slides by sample electrodes 20 passes through the electrolyte within the apertures 50 rather than passing through the bulk slide material). This condition ensures that the capture of analyses is reproducible and that the generation of gases, due to electrolysis of solvent at the surface of the capture slide, is not excessive (i.e., to the point that the gases block passage of electrophoretic current through the porous capture material 40 during electrophoretic steps). In order to achieve this condition during operation of the device usually the volume resistivity of the material used to make the cartridge capture slides 42 will be between 10² and 10¹⁰ ohm-cm. More usually the volume resistivity of the material used to make the cartridge capture slides 42 will be between 10⁴ and 10⁸ ohm-cm. This appreciable conductivity of the capture slide material prevents charging of the capture slide 42 during ionization of the captured analytes in subsequent analysis by MALDI-MS analysis. The conductivity, however, is still low enough to ensure that the capture of analyses is reproducible and that the generation of gases, due to electrolysis of solvent at the surface of the capture slide, is not excessive. Alternatively, the bulk conductivity of cartridge capture slides may be either more, or less conductive, and the surface conductivity is adjusted to achieve the desired condition.

In an alternative embodiment (A), if the bulk conductivity of the capture slides is at the high end of the range specified above (i.e., potentially excessively conductive) then a resistive surface coating may be applied to the slide 42 in order to reduce the amount of current passing through the slide during electrophoretic steps. Subsequently, prior to insertion into a mass spectrometer, the resistive surface coating optionally may be removed to provide the equivalent quantity of electrical conductivity needed to prevent sample charging during MALDI-MS analysis. In still another alternative embodiment (B) of the invention, the bulk conductivity of the capture slides is selected to be at the high end of the range specified above (and in any case less than 10⁴ ohm-cm). In this case, a first conductive surface coating may be applied to the slide 42 in order to increase the amount of current passing over the slide so as to prevent sample charging during MALDI-MS analysis. In embodiment (B) advantageously a first resistive surface coating is applied over the first conductive coating so as to reduce the amount of current passing through the slide during electrophoretic steps. Subsequently, prior to insertion into a mass spectrometer, the resistive surface coating optionally may be removed to provide the equivalent quantity of electrical conductivity needed to prevent sample charging during MALDI-MS analysis.

Once the capture slide 42, with apertures 50, is formed, capture materials 40 may be deposited and attached within the apertures by a number of means, such as attachment of membranes by welding, either with solvents or by heating, casting of the materials into the apertures, or other means of attachment. In a preferred mode, casting is provided by performing grafting via two photopolymerization reaction steps in situ. Both reactions are performed in a mold on a vacuum table by using ultraviolet radiation to initiate photo polymerization. In the method a suitable mold for casting is formed from thermoplastic, thermo set, or metal by machining, or otherwise fashioning the mold. The mold must retain the capture materials 40 within apertures 50, of capture slides 42, and advantageously will exclude oxygen which acts to terminate free-radical polymerization reactions, as is well known to those skilled in the art. For example the mold may be comprised of a thin sheet of material such as polyethylene or “Saran Wrap” that is held in place against the slide apertures by vacuum while the slide is held on a vacuum table, as is well know to those skilled in the art of such molding procedures.

The first photo polymerization step double bonds, or vinyl groups are photografted, to the walls of apertures 50. In the photografting process a photografting solution is placed into the apertures and irradiated with UV light for a time necessary to generate copolymer molecules which are covalently bound to the capture slide material circumscribing apertures 50. When the UV irradiation is provided by a 5000-EC unit from Dymax Corporation Torrington, Conn., USA using an H-lamp, the irradiation time needed generally will be from 1-5 minutes in length.

A suitable photografting reaction mixture consists of 48.5 mass % methyl methacrylate (MMA), 48.5 mass % ethyleneglycol dimethacrylate (EDMA) and 3 mass % benzophenone. The reaction mixture is weighed, mixed and sparged with a gas such as argon, helium or nitrogen to drive out oxygen. The sparged reaction mixture then is placed into the apertures 50 of capture slides 42 by dipping the capture slide into the mixture and then tapping to remove excess. Alternatively the mixture may be applied by pipetting into each aperture 50, or by otherwise delivering the reaction solution to the interior of the apertures. After the apertures are filled with the mixture, the capture slide is placed into the mold described above, the mold is placed on the vacuum table (Pharmacia Fine Chemicals, Model GSD-4) and the vacuum is turned on. A UV-transparent plastic sheet is then placed over the filled apertures the mold in order to apply the vacuum to the mold (i.e., to apply a sealing surface). Such plastic sheet can be provided from commercial plastic wrap such as Saran Wrap, from sheet rubber, such as polydimethylsiloxane sheet, or any suitable UV-transparent gas barrier material. The plastic sheet sealing surface is manually held in place against the capture slide (while it is retained on the vacuum table) until a sufficient vacuum develops to retain the slide. The photografting reaction is then initiated by a UV irradiation device, e.g., a 50-400 W mercury arc lamp, and irradiated for a time. The time of irradiation is dependent on system factors, but is generally less than one minute where the irradiation flux is 100 mW/cm2 of irradiated surface area. Sufficient UV radiation is provided for example by a 400 W Hg lamp operating at a distance of approximately 20 cm from the capture slide surface. After UV irradiation, the transparent plastic cover is removed; the photografted capture slide is removed from the mold and rinsed with acetone. The photografted slide is then placed in acetone and stored there for a time to remove trace amounts of monomers and any segments of copolymer that may remain ungrafted to the surface of capture slides 42.

The second photografting step comprises in situ formation of a solid, but porous, monolith (or microlith mixture) material that is in part covalently attached to the capture slides 42 via the photografted copolymer attached in the previous step. In the present method, monolith (or microlith) formation is carried out by placing a reaction mixture into the wells, forming a low- to no-oxygen environment by vacuum sealing the mold, and irradiating with UV for a time to generate the monolith from a mixture of monomers and porogens. Such porogens are known in the art to promote the formation of porous solids when mixed with reactants that subsequently form a solid phase. The UV irradiation may be provided from an SLM instruments 400 Watt Xenon arc lamp, or alternatively, the UV irradiation is provided by a 5000-EC unit from Dymax Corporation Torrington, Conn., USA using a D-lamp.

In one suitable method, monolith “reaction mixture A” is used. “Reaction mixture A” comprises 5 grams 1-decanol, 2.4 grams n-butyl methacrylate, 1.6 grams EDMA, and 1 gram cyclohexanol along with an initiator. Dimethyl acetophenone (DMAP) is used as the initiator in 1% proportion to the total mass of monomer. Thus in this case 0.4 grams DMAP is used. The reaction mixture is weighed, mixed until the DMAP is entirely dissolved and then is sparged with an inert gas such as argon, helium or nitrogen in order to drive out oxygen. The sparged reaction mixture then is placed into the apertures 50 of slides 42 by first filling the mold with approximately 10 mL of reaction mixture, then placing the slide into the mold described above. Alternatively, the reaction mixture can be pipetted into each aperture 50 or otherwise delivered to the interior of the apertures. The capture slide 42 is then placed into the mold, the mold is placed on the vacuum table (Pharmacia Fine Chemicals, Model GSD-4) and the vacuum is turned on. A plastic sheet is then provided to cover the mold, with sufficient plastic sheet directly atop the capture slide. Such plastic sheet can be provided from commercial plastic wrap such as Saran wrap, from sheet rubber such as polydimethylsiloxane sheet, or any suitable covering material. The plastic sheet is then held in place by holding it down against the vacuum table until the vacuum develops sufficiently to fixture the mold and contained capture slide to the vacuum table. The capture slide part is then placed into a UV irradiation device with a xenon or metal halide arc lamp and irradiated for a time (as described above). The time of irradiation is dependent on system factors, but is generally less than four minutes where the irradiation flux is 150 mW/cm2 of irradiated surface area. Sufficient UV radiation is provided for example by a 400 W Xe lamp operating at a distance of approximately 20 cm from the capture slide surface (SLM Instruments, Champaign, Ill., USA). After UV irradiation, the plastic cover is removed; the monolith-filled (or microlith-filled) capture slide then is removed from the mold carefully and rinsed with methanol. The monolith-filled (or microlith-filled) slide 42 is then placed in about 10 volumes of methanol for 1-24 hours to allow methanol to displace the higher alcohols and remove residual unreacted monomer. Fresh methanol is used to wash each subsequent batch to ensure adequate cleaning.

Many suitable variations (of the both the method and reaction mixture A) exist, as generally are known to those skilled in the art. References 11-22 show examples. Through experimentation we have found that capture materials 42 formed by a heterogeneous combination of two, or more, different capture materials are superior to pure monolithic capture materials when used alone. In general, the heterogeneous combinations, such as those described herein, comprise solid, preformed, particles in combination with an interstitial media. The interstitial media advantageously will be comprised of porous “monolithic” materials such as those described herein (and more generally in references 11-22). Particularly preferred particles are chromatography media consisting of solid or porous core particles. The particles may be so called “reverse phase” particulate chromatography media (i.e., hydrophobic particles, or alternatively may be cationic, or anionic “ion-exchange media,” Generally the particles will be from 1 to 100 microns in diameter. More generally the particles will be from 5 to 50 microns in diameter. Examples of such materials include high purity silica, protein-affinity modified silica, polymeric chromatography porous or solid beads or other solid particulate materials that are known to those skilled in the art of chromatography or in the manufacture of such materials. Alternatively a mixture, or alternating layers of two, or more such media may be used. In each case the particulate chromatography media are held in place by a suitable interstitial media which may be any suitable material which adheres well to the surface of capture slides 42 and also firmly traps the chromatography media in place. Either the particles, the interstitial media, or both, may be porous. Particularly preferred are porous interstitial media, for example, the same compositions mentioned above and taught generally in references 11-22. A combination of porous interstitial media and prorous particles is particularly preferred in order to create a porous capture material with maximal surface area for binding analystes. Also, for capture of molecules having hydrophobic moieties, such as lipids, proteins, peptides and most pharmaceutical drugs, a preferred “reverse phase” heterogeneous combination is preferred. For the capture of proteins and peptides from biological samples, for example, so called “reverse phase” particulate chromatography media (preferably porous beads) are used in combination with a porous monolithic interstitial media. Monolithic material, such as that cited above (and generally in references 11-22).

In particular, a preferred embodiment for the capture of biological peptides and proteins comprises a mixture formed whereby 33% of the “reaction mixture A” is replaced with Alltech SPE Bulk Sorbent C8 (Alltech Associates, Deerfield Ill., Cat No 211504). The general procedure described above for employing pure reaction mixture A is employed with the mixture. Also, advantageously the particulate material helps to increase the viscosity of the reaction mixture containing monomers, cross linker and initiating reagents. The increase in viscosity helps to prevent leakage of the polymerization reaction mixture from the apertures during casting. Thereby the viscosity may be adjusted to a desired value by selecting a predetermined particulate composition, generally ranging from 1% particulate to 99% particulate material. More generally the particulate material will be between 10% and 90% of the total volume of them mixture. Even more generally the particulate material will be in the 25 to 50% range of the total volume of them mixture. Further examples of particulate chromatography particles that may be used to manufacture preferred capture materials for capturing proteins and polypeptides are given in Table 1.

TABLE 1
Example “Microlith” capture chemistry compositions

| Capture Mechanism | Examples |
|---|---|
| Normal Phase | Silica, alumina |
| Reverse Phase | C2-C18, polymeric resins, monoliths |
| Ion Exchange | SCX, SAX, WAX, WCX |
| Immobilized metal affinity | Ni, Fe, Ga |
| Antibody Capture | Protein G, Protein A, Streptavidin, Custom |
| | Antibodies |
| Small Molecule Affinity | Blue Sepharose/Dextran, Custom ligand |
| | libraries |

The example chromatography materials are provided by a number of manufactures in bulk quantities, having particle sizes ranging from 0.2-500 microns. Either porous or nonporous particles may be employed. Porous particles, however, are preferred because of their greater binding capacity per unit volume and because the total porosity of the capture materials 42 is increased. By way of further example, manufacturers include Agilent, Alltech, Applied Biosystems, Phenomonex, Supelco, and Waters. A preferred embodiment of the present invention comprises C8 reverse phase resins, specifically Alltech (part # 206250), bound together with methacrylate resin, as described herein as the capture material. These particle resins combinations demonstrate high utility for the capture of biological macromolecules, including proteins and peptides in particular; and also for carbohydrates, polysaccharides, and oligonucleotides more generally; and provide for their subsequent desorption/ionization by using MALDI mass spectrometry.

Such combinations of unpolymerized resins and prepolymerized particles (when the mixture is subsequently polymerized as a unit) are called “microlith” compositions herein. Such microliths consist of preformed and customarily, commercially-available chromatography media held into a thin capture slide configuration by a MALDI-compatible resin. The specific compositions of such microliths are predetermined according to the composition of chromatography media chosen for embedding within the mixture. Such compositions include but are not limited to normal phase, reverse phase, ion exchange, immobilized metal affinity, small molecule ligand affinity, including antibody-capture affinity and lectin-capture affinity chromatography media, to name a few examples. Other examples are well known to those skilled in the art of chromatographic separations of biomolecules and selection of commercially-available media for such purpose.

An unexpected characteristic of the mixture of porous monolithic material and particulate media is that the combination increases both the strength and the porosity of the solid phase capture material. Thus, pressure-driven flow through microliths constructed according to the methods described herein is much greater than through “monolithic capture materials, as describe both in the available literature, and as described herein. Also the combination (i.e., mixture) of porous monolithic resin and prepolymerized particulate chromatography was found to increase the tensile strength of the resulting capture material (compared to use of either material alone). Thus, (100%) pure porous monolithic capture monolithic materials (e.g., formed from 100% reaction mixture A) when cast into 1 mm diameter apertures tend to crack and lose adhesion to the capture slide surface when dried in a vacuum. In contrast, incorporation of 33% of Alltech SPE Bulk Sorbent C8, prevents such cracking and loss of adhesion. Such heterogeneous compositions, generally referred to as “microliths” are made by the above methods and are found to have superior mechanical strength, stability and have good adhesion in the capture slide surface. Further we have found such “microliths” further to have the capacity to capture proteins, peptides and other analyte molecules in electrophoretic devices. Further such microliths may be cast sufficiently flat (e.g., +/−50 microns to provide and excellent surface for subsequent analysis using matrix-assisted laser Desorption/ionization Mass spectroscopy (MALDI-MS).

Further Composite Materials Containing a Porous Polymeric Matrix Co-Crystallized with Functionalized Silica Beads

Advantageously the hydrophobicity of the capture material 40 in capture slides 42 will be selected to match the desired affinity for captured analytes. The desired affinity required for reverse phase binding (hydrophobicity) generally will be greater for capturing smaller peptides, e.g., from 200 to 2000 Daltons, compared to capturing proteins of greater than 2000 Daltons. On the other hand excess hydrophobicity may be detrimental to the elution and subsequent analysis of the larger proteins after then have been captured on capture material 40. Therefore, the subject invention disclosed here advantageously provides for varying the polymeric matrix composition used to make the capture materials 40 in capture slides 42. For example, butyl methacrylate may be used, as disclosed above, to capture, elute, and analyze proteins. In contrast where greater hydrophobicity is required for capture, elution, and analysis of peptides a more hydrophobic methacrylate, such as lauryl methacrylate may be used instead. Exemplary methacrylates (available from Sigma Chemical Company) for this purpose include the following (listed from the most hydrophilic to the most hydrophobic):
2-Hydroxyethyl methacrylate
methyl methacrylate
butyl methacrylate
hexyl methacrylate
isodecyl methacrylate
lauryl methacrylate
2,2,3,4,4,4-Hexafluorobutyl methacrylate

The solvent compositions that can be used with the methacrylates are disclosed in detail elsewhere, but in general can be 40% decanol and 15% cyclohexanol in the total volume. The photoinitiator, 2-2-dimethoxy-2-phenylacetophenone (DMAP), at a concentration of 8 wt % with respect to the monomer can be employed.

Further fine-tuning of the hydrophobicity can be achieved by employing mixtures of the methacrylates. The porous polymeric matrix may consist of two, or more, methacrylate monomers. For example the monomers may be lauryl methacrylate & ethylene glycol dimethacrylate with a molar ration of 5:1. The final solution also may contain 55% high boiling point solvents for use as a porogen. The solvents that may be used include 40% decanol and 15% cyclohexanol in the total volume. The photoinitiator, 2-2-dimethoxy-2-phenylacetophenone (DMAP), at a concentration of 8 wt % with respect to the monomer may be added to the mixture in order to effect photopolymerization. The selected methacrylate monomers, or monomer mixtures, may be employed together with particles to increase the strength of the porous capture materials, as disclosed herein. For example, 50 um diameter C8 functionalized porous silica beads may be employed for this purpose, as previously described herein. The beads, monomers and porogen solution are mixed in a suitable proportion to create a malleable suspension with the consistence of a paste. The suspension is then photopolymerized into a crystalline matrix as described previously herein. The porogen lastly is removed and replaced with a lower boiling solvent, e.g., methanol simply by a final washing step in the replacement solvent.

In general cross-linkers also will be used together with monomers, as described previously herein. The ratio of monomer to cross-linker determines the strength and hydrophobicity of the solution. In general, ratios between the ranges of 1:1 to 10:1 monomer to cross-linker will be found suitable, with the 10:1 ratio being the most malleable and hydrophobic and the 1:1 being more ridged and less hydrophobic. For example, the monomer used can be any methacrylate with any side group, if the side group is a hydrocarbon, the longer the hydrocarbon the more hydrophobic the microlith material. Lauryl methacrylate produces a strongly hydrophobic microlith while methyl methacrylate produces a weakly hydrophobic microlith. In an alternative embodiment a reactive methacrylate can be reacted with the microlith composition after the microlith is polymerized. An example is glycidyl methacrylate which contains an epoxide side group or 2-hydroxyethyl methacrylate which contains a hydroxyl side group. As a further alternative embodiment, a co-monomer solution can also be used to fine tune the hydrophobicity of the microlith surface or control the number of binding site available. Copolymers combinations like lauryl methacrylate and methyl methacrylate are strongly hydrophobic but have significantly less available binding site in the microlith. Porogen ratios further may be varied in order to control the porosity (and thus electrical resistivity when containing an electrolyte), binding site capacity, and strength of the microlith material. The range of porogen use may include using no porogen all the way up to 80% porogen. More usually the porogen will be between 20 and 50 percent of the total volume, as enough polymer must be present to effectively cement and thereby co-crystallize the silica bead matrix. The porogen type can control the viscosity of the final suspension as well as the pore size in the microlith. A combination of different porogens as disclosed herein can be used to optimize the desired properties of the porous capture material.

The amount and type of photoinitiator may also be used to control the rate and length of the polymer formation. DMAP is a relatively reactive photoinitiator that allows for short exposure to 248 nm light. Other photoinitiators can be used if another wavelength of light is desirable. Also a combination of different wavelength photoinitiators could be used if two or more separate reactions needed to take place.

Further, the particulate beads used to make microliths add support to the co-crystalline matrix as well as adding increase binding capacity to the microlith. Different bead sizes, bead porosity, and coatings on the beads can be employed advantageously to control the porosity, strength and binding capacity of the final microlith. Also a combination of bead sizes and porosities, including non-porous bead can be used to form an optimal microlith.

By way of further example, different silica bead functionalization chemistries can be used to change the hydrophobicity, strength and porosity of the microlith. Beads are added to the monomer solution in suspension until a suitable paste is created. In order to achieve a similar suspension consistency more C2 beads need to be added to a monomer solution than C8 beads. Utilization of C2, instead of C8-coated glass beads decreases the hydrophobicity of the microlith material. Bead surface chemistries can be reverse phase, ion-exchange, normal phase or any other possible functionalized silica bead. Thus analytes can be captured and released based by employing the subject invention by employing ion-exchange capture and release properties, as are well known in the prior art. Further the ion-exchange properties may be combined with hydrophobic capture properties of the capture material 40 within capture slides 42. For this purpose sulfonate, carboxy, amino, diethylamino, and other charged groups may be attached ether to the particle surfaces or to the bulk methacrylate monomers. Thereby affinity of small peptides for the capture material can be further increased advantageously. The percentage of surface area functionalized on the silica bead can also be altered. For example, either a C18 bead or a C18 high capacity bead could be used. The C18 high capacity bead would have more C18 hydrocarbons attached to the surface and would therefore be more hydrophobic

Dissociation and Removal of High Abundance Proteins from Serum

A major problem with analyzing clinically important, low abundance peptides in blood, plasma, or serum is that high abundance proteins mask the appearance of low abundance proteins and peptides. Affinity removal of the most abundant proteins from blood, plasma or serum samples, however, has been hypothesized to also remove a significant number of low abundance, hydrophobic peptides. In a preferred embodiment of the separation and analysis method example, serum samples first were treated with either MALDI-compatible (e.g., acid-cleavable detergents such as those known as Rapigest, available from Waters Corp. or PPS, available from Protein Discovery, Inc.), neutral (i.e., uncharged) or zwitterionic detergents in order to promote dissociation prior to subsequent molecular weight fractionation to remove high abundance, high molecular weight proteins.

All samples were either applied to stainless steel sample plates or to disposable capture slides made of a flat polymeric material having an electrically-conductive surface, such as those described above. For example, 2 microliter (ml) sample volumes may be applied either directly as a droplet of solution, or electrophoretically captured on monolithic capture materials that, after drying, may be placed directly into a MALDI mass spectrometer. By way of further example, 0.5 ml of MALDI matrix solution may be pipetted onto the sample spots and allowed to dry. Proteins and peptides generally are analyzed with alphacyano-4-hydroxycinnamic acid (CHCA) employed as the MALDI matrix, since it generally provides the best signal to noise MALDI-mass spectrometry results for low molecular weight peptides and polypeptides from 1,000 to 15,000 Daltons (Da). The composition of the CHCA matrix solution may be as follows: CHCA is saturated in a mixture of 50% acetonitrile and aqueous 0.1% trifluoroacetic acid. All materials for the MALDI matrix solutions may be obtained from Sigma Chemical Co (St, Louis, Mo., USA). All MALDI-MS analyses may be performed with an ABI Voyager DE MALDI-TOF and a QGEN_PR2 method, optimized as generally known to those skilled in the art of mass spectromery. Typical spectrometer settings are: 20 kV accelerating voltage, 94.1% grid voltage, 0.050% guide wire voltage, 110 ns delay, 3000 laser setting, 64 scans averaged, 1.1e-6 torr, 511 low mass gate, negative ions off.

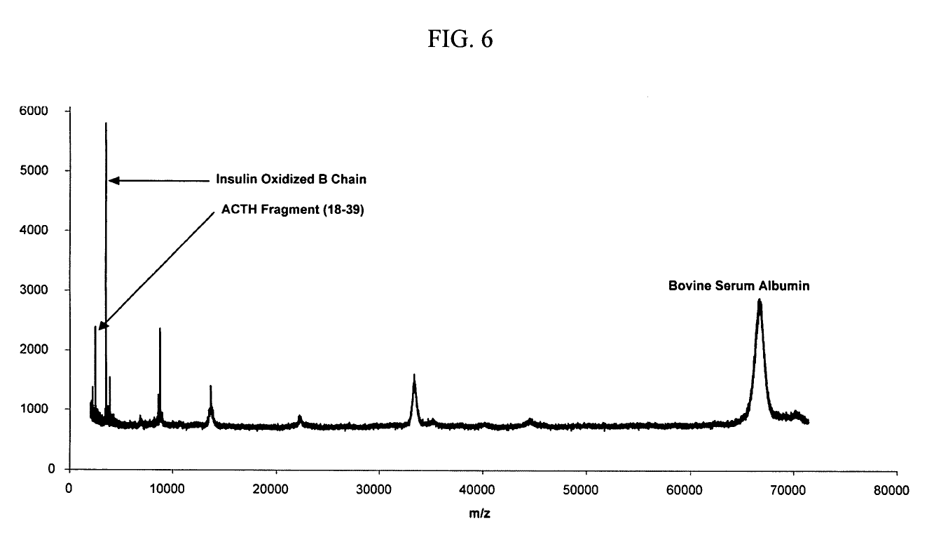

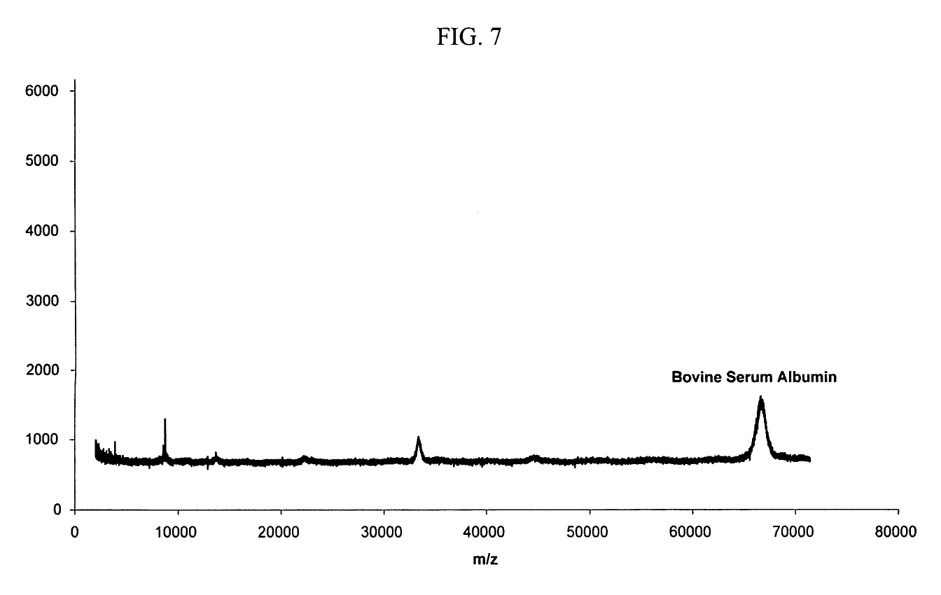

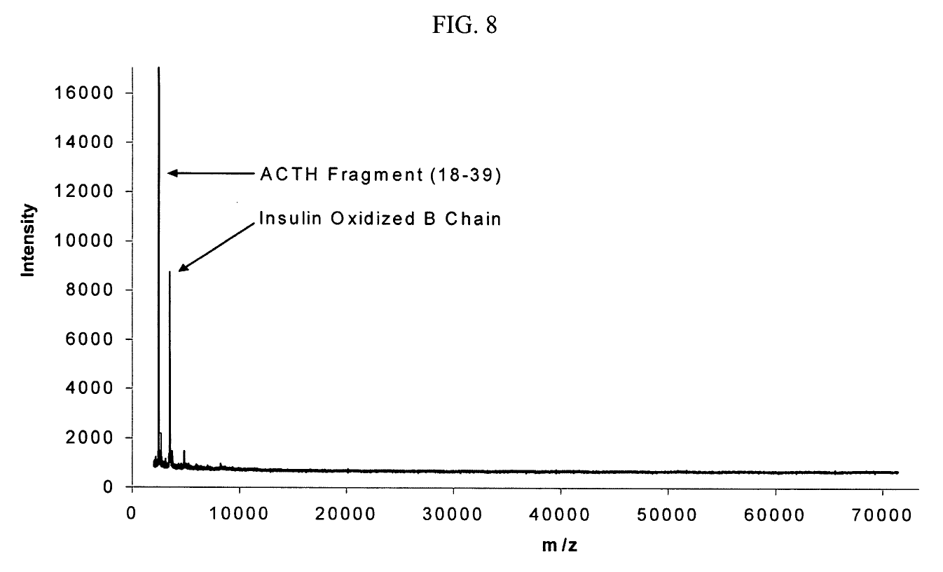

For example, two polypeptide standards, e.g., ACTH fragment (18-39), and insulin oxidized B chain, may be mixed together with bovine serum albumin (BSA) and pipetted directly onto a stainless steel MALDI target plate. FIG. 6 shows these two such polypeptide standards diluted to 1 picomol (pmol), while in the presence of ˜127 pmol BSA, applied to replicate spots on a MALDI mass spectrometer plate, MALDI matrix added in 0.5 microliter volume, the resulting spots allowed to dry, and then separately analyzed for both molecular mass and ion intensity (each peptide standard alone and also when in the presence of ˜127 pmol BSA). FIG. 6 shows that the 1 pmol of ACTH fragment and 1 pmol of insulin can clearly be distinguished. However, as shown in FIG. 7, when the amount of peptide fragments was 10-fold less, i.e., 0.1 pmol of the two standards, together with the same (˜127 pmol) amount of BSA, the BSA substantially suppressed ionization during analysis by MALDI mass spectrometry. Shown in FIG. 8 is a MALDI-TOF spectrum of the same sample employed for the results seen in FIG. 7. For the results seen in FIG. 8, however, the sample was first prepared by electrophoresis (i.e., an electrophoretic separation step), concentration and capture on a capture slide. The procedure entails using a cartridge with a single capture slide (as shown in FIG. 3). In the procedure 2 μL of the sample was combined with 250 mM aqueous L-histidine buffer and processed by electrophoresis and capture on a single capture slide 42 having a monolithic capture material 40 in apertures 50. Capture of the peptides is allowed to occur by passing approximately 1 milliamp of current for a sufficient period of time so that the total charge transferred is approximately 1 coulomb. The results shown in FIG. 8 show that the system effectively removes the BSA as interference from the sample mixture. Thereby the ion intensity of the detected peptides was substantially increased, thereby demonstrating the utility of the system for increasing the sensitivity of detection of low abundance peptides in the presence of higher abundance proteins such as BSA. These results demonstrate that the device and protocols when used in combination effectively remove substantial signal interference from detection of lower molecular weight proteins and polypeptides (i.e., less than 30,000 Daltons) caused by larger proteins such as albumin, (e.g., greater than 30,000 Daltons, thereby dramatically enhancing the mass spectrometry signal obtained from low molecular weight molecules.

### LMW Human Serum Analysis

Peptide and proteins have been monitored by mass spectrometry by employing the embodiments of the invention described herein by using a single cartridge capture slide 42 contained within cartridges 2. Such studies have been conducted to determine feasibility of preparation of human serum for low molecular weight protein/peptide profiling via MALDI MS according to protocols of the instant invention. For example, detergent-treated serum samples are made by adding 10 ˜g/μL octyl-b-D-glucopyranoside (OG) to 100 μL of human serum (obtained from Sigma Chemical Co.) in an Eppendorf microtube (500 μL volume). Samples are then made from 10 μL aliquot of the detergent-treated serum, 100 μL of 250 mM histidine buffer, 1 μL of Texas Red labeled-Leu Enkephalen (as a tracer in 250 mM histidine buffer) and 0.5 μL of glycerol. The resulting sample mixtures then are centrifuged at about 1000 g for 1 minute in order to bring together the mixture droplets. In order to perform separation and subsequent capture of sample analyte components, a 10 μL aliquot of the prepared sample may be added to a sample well. A cathode made of platinum may be placed directly into the sample well. The opposing, counter electrode, may be a platinum anode that is placed in contact with counter electrode electrolyte in a counter electrode chamber (as shown in FIG. 2, for example). The platinum anode and cathode electrodes are connected to a potentiostat (Princeton Applied Research, model 273) and approximately 1 mA of current is applied between the electrodes. Separation is allowed to proceed for about 20 minutes before the voltage is set to zero and the leads to the electrodes disconnected.

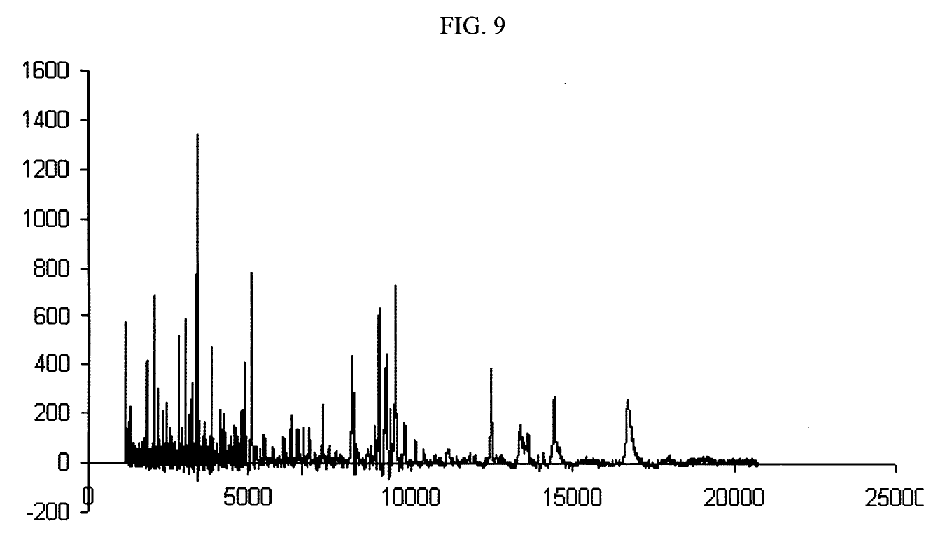

Next, the prototype cartridge is disassembled and the gels and capture layer checked for fluorescence. The analytical system is performing well when essentially all fluorescence from the proteins and peptides selected to electrophoretically migrate toward the capture materials 40 is observed to bind to the capture sites on a capture slide. The capture slide then is washed by immersion (soaking) in deionized water for approximately 5 minutes. After visual inspection of the fluorescent capture sites, the slide is allowed to air dry completely. Next, a 0.5 μL aliquot of MALDI matrix is applied to the topside (top surface, 41) of the capture slide 42 to the porous capture material 40. After allowing the matrix to dry, the areas of matrix application are analyzed directly by direct interrogation with the MALDI (pulsed nitrogen) laser beam in a Voyager DE MALDI MS. FIG. 9 shows the mass spectrum obtained from a sample by using CHCA as the MALDI matrix. The Figure shows good signal to noise ratios for the detection of low molecular weight polypeptides from human serum.

When using similar parameters described in the above example, blood serum may be applied to two wells within a PPAS cartridge. One, or more, of samples may be treated with a detergent to promote dissociation of proteins, on from the other. In so doing, detergent-treated samples may be combined with 250 μL of L-histidine, adjusted to pH 6.8 and current applied at 1.0 mA by means of polarizing a sample electrode in contact with the sample. The other detergent-treated samples may be combined with 250 μL of L-histidine, adjusted to pH 7.0 and similarly biased with a sample electrode to provide a current of −1.0 mA. As shown in the Figures, the spectra observed from the two, oppositely-polarized sample wells show completely different, complementary protein and peptide peaks. These data clearly demonstrate the advantageous binary pH fractionation of the same sample.

### Further Examples and Methods

Materials. All materials are available from commercially vendors and include: acetonitrile, trifluoroacetric acid (TFA), n-octoglucoside, CHCA, L-histidine and polyacrylimide. Serum preparations may be conducted in 0.5 mL polypropylene tubes from Sigma Co. The C-18 coated superparamagnetic beads used for preparing microlith capture materials may be purchased from Bruker Daltonics.
Serum Samples. Blood samples from volunteer subjects with no known malignancies and from consenting patients with confirmed prostate cancer (Gleason scores 6-7) may be provided in 8.5 mL glass Vacutainer tubes, allowed to clot at room temperature for up to 1 hour, and centrifuged at 4° C. for 5 min at 1000 rpm. Sera may be aliquotted and stored frozen at −80° C. Patient and control sera may be collected following a clinical protocol approved by Vanderbilt University Medical Center.
Chromatographic Separations. In selected cases, sera may be either fractionated by using reverse phase magnetic beads or the PPAS device described herein.
Magnetic Bead Chromatography. Sera may be incubated (e.g., at room temperature in contact) with superparamagnetic, porous silica-based particles (<1 μm diameter; 80% iron oxide), surface-derivitized with C18. A suspension of C18/K magnetic particles (500,000 particles/μg; 50 μg/μL DD water) may be thoroughly mixed for 2 min. by vortexing to obtain homogeneous dispersion. Next, a 50 μL bead solution may be added to 50 μL of serum and mixed slowly by pipetting up and down five times. A magnet may then used to pull the beads to the side of the tube while the supernatant is removed via pipette and discarded. The beads may then be washed thoroughly with 200 μL of 0.1% TFA in water. Finally, the peptides may be step wise eluted from the particles with 5 μL volumes of 20% and then 70% acetonitrile by pipetting the beads up and down 10 times. 3 μL of the eluate may then be transferred to another tube, mixed with 6 μL of MALDI matrix solution, and 1 μL deposited for MS analysis.

### Fractionation/Concentration of Sample Analytes by Using a PPAS Device

For casting of capture materials 40 in capture slides 42, a carbon doped polypropylene (˜50,000 ohm/cm) slide containing a plurality of through holes is injection molded. The slide is then sandwiched between two soft silicon rubber gaskets, and two quartz plates. The functionalization solution (described previously to “vinylize” the capture slides in order to provide for covalent attachment of capture materials 40) is placed via pipette into each of the through holes (apertures, 50) and illuminated by using the Xenon Arc lamp fitted with a water filter for approximately 15 min. The substrate (capture slide 42) is then removed from the sandwich and a monolith solution, containing butyl methacrylate and 2-hydroxyethyl methacrylate, is added to each of the through holes (apertures, 50) as previously described, and the sandwich reconstructed and illuminated for 15 min. Following this casting procedure, the slide is washed by soaking in a solution of 106 mM ammonium biocarbonate and 250 mM L-histidine for 30 minutes. Finally the capture slide 42, containing monolith capture materials 40 in apertures 50 is thoroughly washed with deionized water.

Protein and peptide analytes may be analysed by using the general protocols described above. By way of further example, upon arrival the serum aliquots may be immediately stored at −80 degrees ° C. The blood serum samples may be prepared subsequently for analysis, for example, by adding 250 μL of 16 mM ammonium bicarbonate and 250 mM L-histidine to 1 μg/μL octyl-b-D-glucopyranoside (OG), 0.5 μL glycerol and 10 μL of human serum in an Eppendorf microtube (500 μL volume). The resulting sample mixtures may be centrifuged at about 1000 g for 1 minute in order to bring together the mixture droplets. One-half of the samples may be adjusted to pH 7.0 and other half adjusted to pH 6.8. 160 mM ammonium bicarbonate and 250 mM L-histidine buffer may be used for the cartridge reservoir buffer (below the monoliths). All samples may be analyzed in five replicate runs.

For carrying out electrophoretic separation and electrochromatographic capture of sample analytes onto the capture materials 40, within the slide 42, the sample well electrode 20 (in this case a cathode) is made of platinum may be placed directly into the sample wells 4. A platinum anode (as counter electrode 70) may be placed in contact with the buffer reservoir. The platinum electrodes may be connected to a custom-designed, multiplexed potentiostat and approximately 1 mA of current may be applied to each sample well electrode. The process may be allowed to proceed for about 20 minutes before the voltage is set to zero and the leads to the electrodes disconnected. One-half of the samples may be processed at +1 mA, and the other half at −1 mA, each for approximately 20 minutes. During the course of each analysis, the current for each of the wells may be monitored and plotted. After the electro-concentration procedure is complete, the PPAS cartridge 2 may be disassembled and the cartridge capture slide 42 then is washed (as described previously) to remove interfering species such as pH buffers and salts. Lastly, a CHCA-containing MALDI matrix may be applied (as described previously) and the slide directly analyzed via MALDI-MS (as described previously).

For both the PPAS device protocol and the magnetic beads, 30 fmol (per peptide standard) and 500 fmol (per protein standard) of commercially available calibration standards (Bruker Daltonics) may also be mixed with CHCA matrix and applied separately onto the target plates, centrally located to six neighboring serum samples, together arrayed in a 3×2 pattern. Reproducibility may be determined to assess variability in: a) a single well in a single device, b) different wells of the same device, c) the same wells of different devices, and d) different wells of different devices. A factorial analysis may be used to determine effects of well position, interactions between the wells (or other variables).

Mass Spectrometry. Peptide profiles may be analyzed with Applied Biosystems Voyager DE and 4700 model MALDI mass spectrometers by using the typical procedures: 20 kV accelerating voltage, 94.1% grid voltage, 0.050% guide wire voltage, 110 ns delay, 3000 laser setting, 64 scans averaged, 1.1e-6 torr, 511 low mass gate, negative ions off. Spectra may be acquired in linear mode geometry. In general for MALDI MS analysis, the cartridge slide 42 is affixed to a suitable MALDI mass spectrometry sample plate holder for introduction into a MALDI mass spectrometer. A small droplet (e.g., 0.1 to 0.5 uL) of MALDI matrix dissolved in a suitable solvent is then added to the analyte capture regions of the capture membrane. The solvent is allowed to dissolve the analytes present at the capture sites on the capture membrane. As the solvent evaporates, the analytes become incorporated within MALDI matrix crystals that form on the top surface of the capture membrane. After allowing time for evaporation of the solvent liquid and formation of MALDI matrix crystals, the sample plate is ready for introduction into a MALDI mass spectrometer. Upon insertion of the MALDI sample plate into a mass spectrometer, the MALDI matrix crystals are illuminated with an intense UV laser light pulse resulting in ionization of a fraction of the analyte molecules. Ions from this fraction are measured based on their time of flight to the detector and plotted according to their mass-to-charge ratio and intensity.

### Example Analysis of Proteins Present in Blood Serum

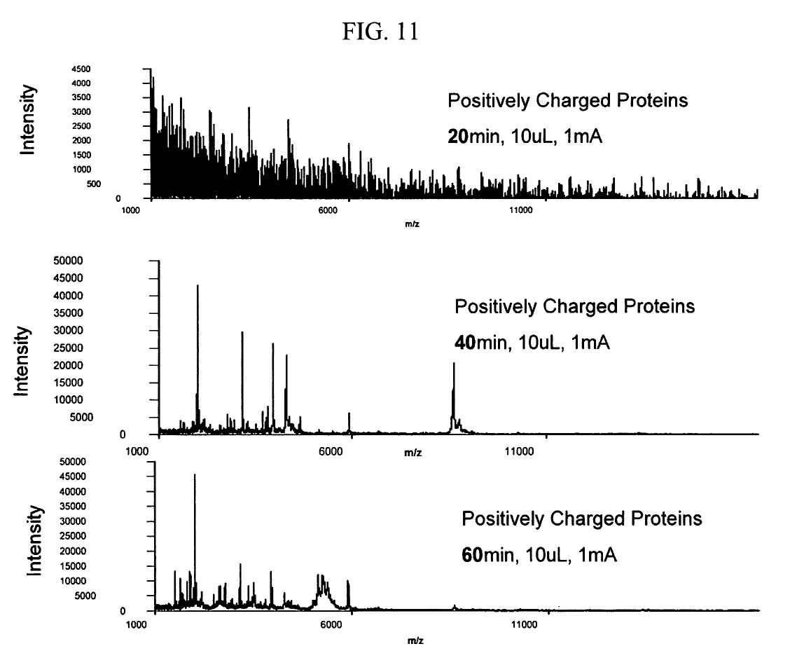

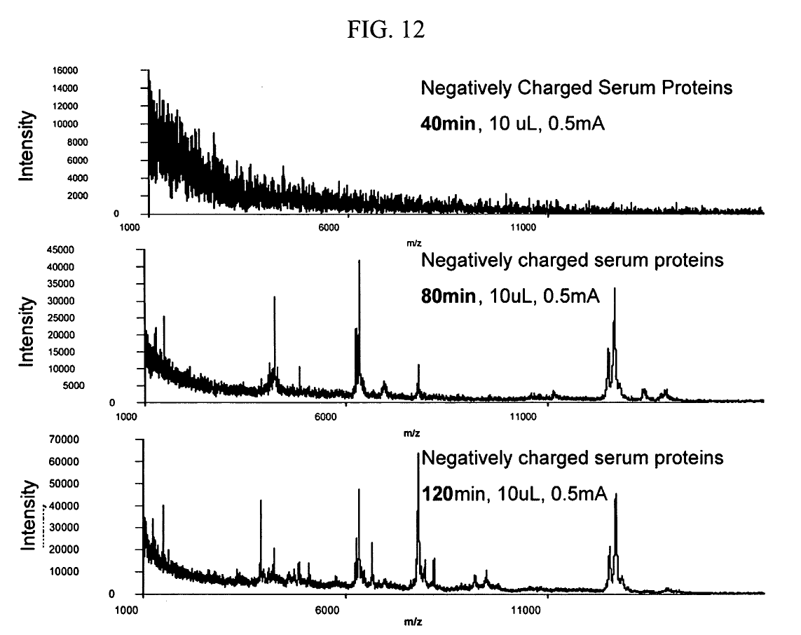

FIGS. 11 and 12 show the results of utilizing a 25-well version of the PPAS, with single capture membrane, and subsequent analysis by MALDI mass spectrometry. Using the prototype PPAS, separations from an array of serum samples have been carried out simultaneously at relatively high speed (within 60 minutes). Subsequent reductions of the thickness of the separation layer from about 5 mm to about 1.0 mm, or less and increasing the voltage applied across the separation layer from about 1.0 to 10 volts to about 10 to 100 volts enables separation, concentration and capture in 10 minutes, or less. Electrophoretic concentration of selected fractions directly onto the disposable MALDI plate provides the additional benefit of increased MALDI-MS sensitivity and rapid differential expression profiling. A major problem with analyzing clinically important, low abundance peptides in blood, plasma, or serum is that high abundance proteins mask the appearance of low abundance peptides. Affinity removal of the most abundant proteins from blood, plasma or serum samples, however, has been hypothesized to also remove a significant number of low abundance, hydrophobic peptides. In these studies, serum samples were treated with MALDI-compatible detergents in order to promote dissociation and subsequent separation and concentration using the PPAS and detection via MALDI-MS. Examples of such MALDI-compatible detergents are those of neutral charge, such as Triton X-100, octyl glucoside, NP-40, or the like. Such neutral detergents do not electrophoretically concentrate in the PP capture layers.

The results from MS analysis of PP mixtures may be compared to purified PP standards (e.g., a sample containing only ubiquitin, cytochrome C, insulin and 1% TFA). The standard samples may be diluted directly into 0.1% TFA (to either 800 femtomol/μL or 10 femtomol/μL) so that little, or no, interfering species are present after evaporation of the solvent prior to analysis by MALDI-MS. Alternatively, PP labeled with chromophoric or fluorophoric labels may be incorporated as standards. For example fluorophoric moleucules may be labeled with Fluorescein (F) Texas Red (TR), Rhodamine (Rh) or Marina Blue (MB) by employing reagents and methods well known to those skilled in the art of protein modification. Thus either 0.2 μL of TR-ubiquitin, MB-bovine serum albumin (MB-BSA), each at 1-2 μg/μL, may be incorporated into a 2 μL sample containing 250 mM aqueous L-histidine buffer with 25% (w/v) glycerol.

The results shown in FIGS. 11 and 12 were obtained with a polyacrylamide layer used to remove high molecular weight, high abundance proteins from human serum. No albumin was observed (at m/z of 68,000) in the spectra shown in FIGS. 11 and 12. These results show that the polyacryamide layer effectively removes serum albumin, as MALDI-suppressing interference, from the mixture. When the electrophoresis run time was extended to over 1 hour, however, the beginning of an albumin signal was observed. Concomitantly, a reduction in intensity of the other captured proteins is observed presumably due to the well-know suppression of ionization of lower abundance proteins in the presence of the high abundance albumin. For analysis of high molecular weight proteins in the PPAS the polyacrylamide layer may be replaced by a non-sieving agarose layer (and high abundance proteins removed by alternative treatments, e.g., by affinity chromatography).

The PPAS invention captures proteins and polypeptides onto a solid-phase capture membrane, allowing salts and other interfering molecules to be washed away. Then upon application of a MALDI matrix solution to the membrane, the proteins are released and are incorporated into MALDI matrix crystals that precipitate on the membrane surface. After MALDI matrix addition, the membrane is dried and inserted directly into a MALDI-MS instrument for quantification of mass and relative abundance of the attached proteins.

The PPAS may utilize just one capture membrane with (only limited) fractionation into either positively charged or negatively-charged molecules at the selected separation pH. The PPAS with one capture membrane provides for removal of high-abundance proteins (either by an incorporated sieving layer, or carried out in a preliminary step). No other fractionation need be performed. Optionally two, or more capture membranes may be employed in series to further increase the fractionation. Because MALDI-MS is subject to suppression of sample ionization by high abundance molecules, such an increase in fractionation increases the sensitivity approximately in proportion to the fractionation performed.

A basic example of the invention is shown with an alpha prototype system. The prototype system has a 5×5 array of 25 of capture wells and allows 25 samples to be electrophoretically separated and captured simultaneously in a single cartridge. For the mass spectrometery results shown in FIG. 11, the sample pH was 7.8 and the current in each well was set to 1 ma for the times indicated. After capture of the proteins, the membranes were washed in DI water and then released by application of a MALDI matrix solution comprised of one volume of 0.1% trifluoroacetic acid solution saturated with alphacyano-4-hydroxycinnamic acid (CHCA) and one volume of acetonitrile. The matrix was then allowed to dry and placed in a MALDI mass spectrometer for analysis. The time course shows that between 20 and 40 minutes was required for arrival of the initial positively charged proteins and that additional proteins arrived between 40 and 60 minutes. Not shown are data that indicate that there is no substantial change in the captured proteins observed subsequent to 60 minutes. These MALDI-MS analyses were performed with an ABI/Perceptive Biosystems Voyager DE (MALDI-TOF) instrument by using a QGEN_PR2 custom interrogation method, which served to help automate the procedure. For use with CHCA matrix solutions typical spectrometer settings were: 20 kV accelerating voltage, 94.1% grid voltage, 0.050% guide wire voltage, 110 ns delay, 3000 laser setting, 64 scans averaged, 1.1e-6 torr, 511 low mass gate, negative ions off. For use with the sinapinic acid matrix solutions, typical spectrometer settings were: 25 kV accelerating voltage, 92.0% grid voltage, 0.30% guide wire voltage, 200 ns delay, 3800 laser setting, 64 scans averaged, 1.67e-6 torr, 1000 low mass gate, negative ions off.

For the MALDI mass spectrometry results shown in FIG. 12, the procedure and analysis were similar to those described in FIG. 11, except that the polarity of the electrodes was reversed. Thus the proteins observed under the two conditions (of reversed polarity) clearly are different, in accordance with the fact that the native charge of the proteins observed in the two spectra are opposite at the predetermined pH of the sample (i.e., 7.8 in this case). Similar to the results with the positively-charged proteins (FIG. 11), the time course for capture of the negatively charged proteins shows that between 40 and 80 minutes was required for arrival of the initial negatively-charged proteins and that additional proteins arrive between 80 and 120 minutes. Also not shown are data that indicate that there is no substantial change in the captured proteins observed subsequent to 120 minutes. (Note that the current levels for the experiment shown in FIG. 11 are twice as large as the current levels employed in the experiment shown in FIG. 12. Conversely the electrophoresis times shown in FIG. 11 are half of those shown in FIG. 12, i.e., the number of coulombs of charge transfer employed during electrophoresis (for twice the period of time) are identical to those at half the time, shown in FIG. 11. (Thus the charge transferred in the two experiments shown.)

### Gleevec Quantitation Utilizing the Subject Invention

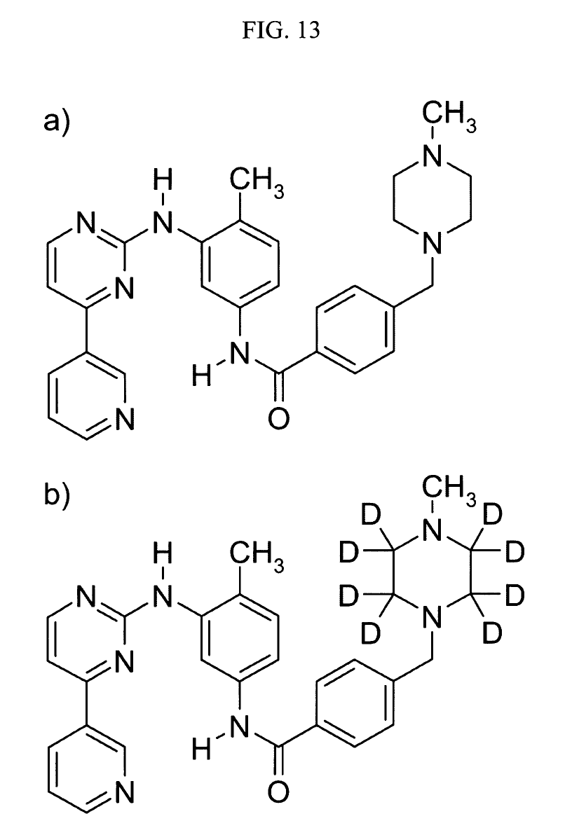

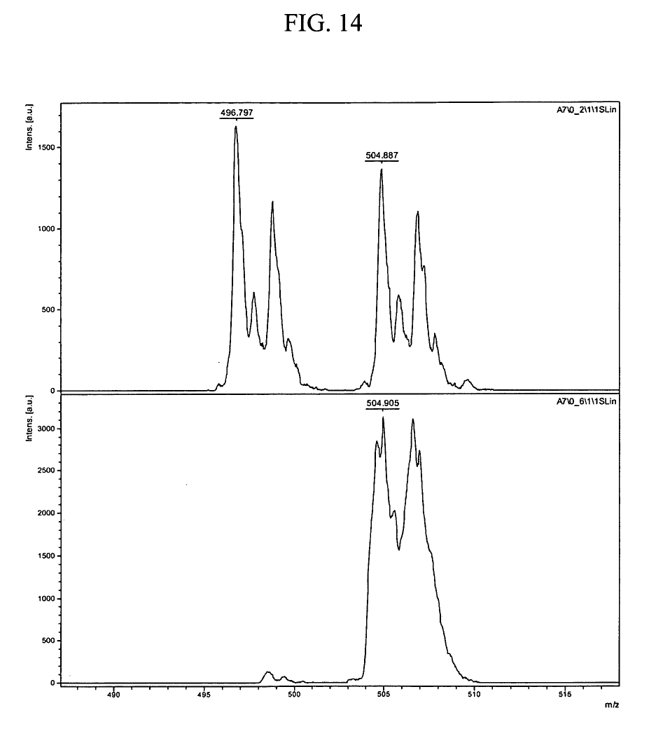

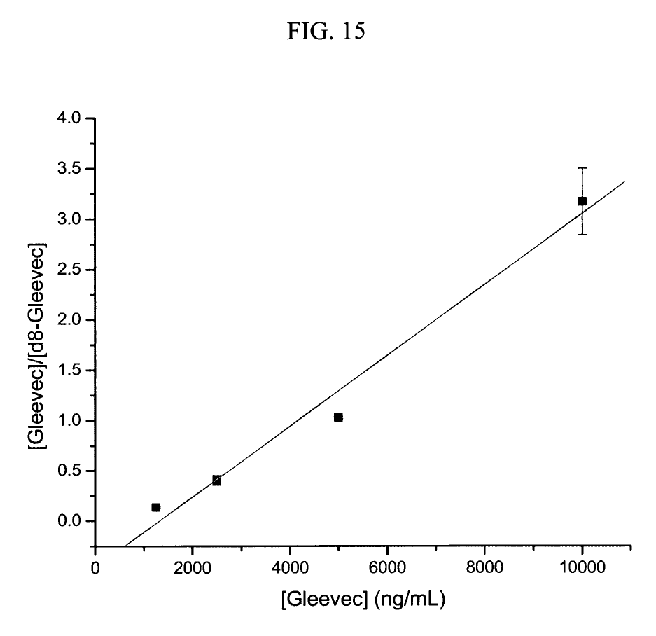

In addition to using the methods and devices of the invention to separate or capture analyte peptides, polypeptides and proteins, the devices of the invention may also be used to capture small charged molecules, such as drugs and metabolites, from a sample. For example, Gleevec (see FIG. 13) was diluted in human serum at concentrations of 625, 1250, 2500, 5000, and 10000 mg/ml. Sample buffer was then spiked with d8-Gleevec (see FIG. 13) at a concentration of 5000 ng/mL and mixed with the Gleevec/human serum samples at a 1:1 ratio. Ten microliters of each sample was loaded into individual sample wells of the MES cartridge and run for 16 minutes for 0.5 C in both anion and cation mode. Under these conditions, Gleevec is a cation at pH 5.2. Mass spectrometry results and analysis are shown in FIGS. 14 and 15. In particular, Gleevec demonstrated a linear response over the range of concentrations tested with a limit of detection at approximately 625 ng/mL.

### Further Methods for Utilizing the Subject Invention for MALDI-Mass Spectrometry Analysis

MALDI matrix may be prepared by using previous published methods subsequently may be applied to the cartridge capture slides 42 by using one of the following general procedures:

1) Manual pipette application,

2) Application using a commercial liquid handling workstation,

3) Spray coating, or

4) Immersion of cartridge capture slide in matrix solution.

For each procedure, a concentrated matrix solution is applied is order to achieve a matrix-to-analyte ratio acceptable for MALDI analysis.

One particularly useful application procedure comprises depositing on the surface of capture material 40 a solution of Sinapinic acid (20 mg/mL in 50:50 acetonitrile/0.1% trifluoroacetic acid). A volume of 0.25 uL of this solution is applied to the top of the cartridge capture slide 42 by using a micropipette. This solution is dried at room conditions over the course of approximately 5 minutes, at which time an additional 0.25 uL of matrix is applied. The slide is allowed to dry at room conditions or in a vacuum desiccator.

Customarily, after MALDI matrix deposition and drying, capture slides are introduced into a MALDI mass spectrometer according to instrument manufacturers specifications. The slides are designed to fit into a specially designed sled that adapts the cartridge capture slide to the x-y sample stage of the MALDI mass spectrometer. The sled is designed to conform to the following requirements: A) The cartridge capture slide must be held perpendicular to the axis of ion extraction inside the mass spectrometer, B) the sled must interface with the cartridge capture slide in a way that provided a path for the dissipation of surface charging of the cartridge capture slide, C) the cartridge capture slide surface height must match that of each instruments standard sample carrier, and D) the position of each monolith relative to the sled must always be the same. Each of these requirements is known to one skilled in the art of mass spectrometry.

Mass spectra of analytes captured on the capture slides 42 are processed in a standard fashion by using sets of tools available commercially and well known to those skilled in the art of such analysis. For example, baseline subtraction, normalization, peak detection, and spectral alignment are performed by using software commercially available as ProTS-Data (Efeckta Technologies, Inc.; Steamboat Springs, Colo.; Version 1.1.1.0) The data analysis, in summary is as follows:

1. Background estimation/subtraction: Background signal is estimated by using robust, local, statistical estimators. As background is essentially “noise” and does not contain biologically relevant information and varies from spectrum to spectrum, amplitude information needs to be made more comparable by subtracting the value of the background from each spectrum.

2. Normalization: The amount of sample ionized can fluctuate from spectrum to spectrum, due to changes in laser power, variations in the amount of ionizable sample, and variations in the positioning of the laser on the MALDI plate. To obtain more reliable quantitive information on the peak amplitudes spectra are normalized to the total ion current.

3. Peak picking: The noise estimators are calculated and used to identify peaks in a spectrum and to assign a reliable estimate of their signal/noise ratio. For a typical MALDI spectrum from tissue samples we typically detect between 100 and 200 peaks with a signal/noise ratio cutoff of 3.

4. Spectral alignment: The absolute mass scale of single spectra can vary considerably. A selection of common peaks can then be used to register spectra to a common m/z scale.

By way of further detailed example, spectra acquired via MS instrument software may be further processed by using commercially available software (e.g., the software obtained from Efeckta Technologies, Corp., Steamboat Springs, Colo.). This software provides automated smoothing, baseline correction, and peak designation of spectra during acquisition. All data manipulation may be made in accordance with techniques described by Tempst et al., 2004, Anal Chem. 76: 1560-70. After manually implemented external calibration, the peak (i.e., m/z) lists may be saved to a file in text file format required for subsequent statistical analysis (see below). Peak lists may be imported into the database for a series of data transformations. To first create a simple binary system for initial pattern analysis, peak intensities may be reduced to indicate the presence or absence in any of the resulting bins of the peptides observed in any particular sample.

Next, the peaks may be aligned across all samples within a particular set by binning within a window expanding proportionally with peptide mass (e.g., 1500 ppm). Binning is done by merging all m/z values from all samples into one long list, sorted by increasing value. The first mass is then marked as “real” and compared to the adjacent sorted masses. Any adjacent masses within a user-defined window are called “duplicate”. The process is repeated with the next larger m/z value that has yet to be marked until all the masses in the sorted list are tagged as either “real” or “duplicate”. “Duplicate” masses are then discarded. In the current application, the tolerance may be either 2 Da or 1500 ppm (0.15%), depending on the experiment. Note that the assignment of the first m/z value in each bin of masses as the “real” mass is arbitrary and is used solely as a designation for the bin. Once the m/z values are binned, a spreadsheet is automatically exported with the results. The first column will show a list of all the “real” masses surviving the binning process. The remaining columns will represent the samples and whether each sample has a peak binned with the corresponding “real” mass.

Statistical Data Analysis. After binning of m/z peaks across all samples of a study set, commercially available software, e.g., Efeckta software, may be used to evaluate proteomic data. A virtual “experiment” may be created in the software to represent the masses. The data may be normalized by using ubiquitin, and at least one other peptide peak found in all of the samples. In the parameter section of the experiment, the samples may be labeled as either Cancerous or Normal, for example. In the Interpretation section, the Analysis mode may be set to “log of ratio” and all measurements used. Sample Names may be displayed as noncontinuous parameter. Once the experiment is created, the masses may be filtered by using a one-way ANOVA nonparametric test (Mann—Whitney U test) and no multiple test correction at p<0.05. This test is meant to filter out masses that do not vary significantly across two different groups with multiple samples. The filter leaves behind masses that exhibit important changes between the prostate cancer and control groups. The changes may be confirmed by using two techniques: for example, clustering and class prediction.

For the first technique, a clustering tool contained within the Efeckta Software may be used and its results displayed as a “decision tree.” On the x-axis of such a “tree”, samples that are similar may be placed near each other. Similarity of samples will be assessed by Pearson correlation. Dissimilar samples will be placed apart from each other. On the y-axis of such a “tree”, masses are grouped in the same way also using Pearson correlation to test for similarity. The clustering method discarded masses with no data for half the samples. For the second confirmation, the filtered peptide masses from the nonparametric test will be also analyzed by class predictor algorithm, called k-nearest neighbor. To learn the accuracy of the class prediction, a suitable cross-validation method may be employed. One such suitable method is known as “leave-one-out”⁶. The method takes N −1 samples as a training set in the class predictor algorithm. The Nth sample is then used as a test set, and the process is repeated N times such that all samples are used as a test set once.

### Classifier Generation and Validation

Within standard mass spectroscopy analyses, mass peak lists (containing the centroid values and normalized intensities) are constructed and then exported to individual data files. A variety of Software tool sets facilitate the detection of biomarkers from mass spectra from these data. The Software at the same time provides rigorous tools for the assessment of statistical significance across different populations with a common variance. While feature ranking gives some idea about the importance of features for discriminating groups, a more thorough analysis requires the use of features in a supervised learning procedure. In supervised learning one provides a category label for each instance in a training set, i.e., each spectrum, and seeks to reduce the number of misclassifications. A large variety of procedures have been developed to address supervised learning problems. The output of supervised classification algorithms generally may be used as a classifier (dependent on the training set) that generates a class label for a new instance or spectrum (see, e.g., A. Webb, A. John Wiley & Sons Ltd., 2002, Statistical pattern recognition; B. Duda, O. R., Hart, P. E., Stork, D. G., Wiley & Sons Ltd., 2001, Pattern Classification).

The invention has been described with reference to various specific and preferred embodiments and techniques. However, it should be understood that many variations and modifications may be made while remaining within the spirit and scope of the invention.

Further information useful when employed together with the subject invention, and herein incorporated by reference, are the following:
Knochenmuss, 2004, Anal. Chem. 76: 3179;
Zalluzec et. al., 1994, J. Am. Soc. Mass Spectrom. 5: 230;
Andrews et. al., 1996, Anal. Chem. 68: 1910;
Costello et. al., 1999, Rapid Commun. Mass Spectrom. 13: 1838;
Peterson et al., 2003, Anal. Chem. 75: 5328-35;
Fréchet et. al., 2003, Macromolecules 36: 1677-84;
Fréchet et. al., 2004, Journal of Chromatography 1044: 3-22;
Fréchet et. al., 2003, Electrophoresis 24: 3689-93;
Fréchet et. al., 2004, Journal of Chromatography 1051: 53-60;
Svec, 2004, J. Sep. Sci. 27: 747-66;
Fréchet et. al., 2004, Rapid Commun. Mass Spectrom. 18:1504-12;
Ericson et al., 1997, J. Chromatogr., 67: 33-41.

What is claimed is:

1. A device for electrophoretically separating, concentrating, and capturing an analyte in a sample comprising:
a sample well for retaining a fluid sample in an electrolyte;
a separation layer providing a path for diffusive ionic, and fluidic communication with the well; and
a capture layer providing a path for diffusive ionic, and fluidic communication with the separation layer;
wherein the capture layer is a porous material further comprising beads.

2. The device of claim 1, wherein the beads are polymer, glass, or ceramic.

3. The device of claim 1, wherein the beads are from 10 microns to 200 microns in diameter.

4. The device of claim 1, wherein the surface chemistry of the beads is reverse phase, ion-exchange, or normal phase.

5. The device of claim 1, wherein the capture layer is a hydrophobic porous polymer, a hydrophilic porous polymer, or a mixture of hydrophilic and hydrophobic polymers.

6. The device of claim 1, wherein the capture layer is a porous poly(vinylidene difluoride) material.

7. A device for capturing a sample analyte for analysis in a mass spectrometer comprising:
a cartridge capture slide comprising a plurality of apertures disposed therein;
a plurality of capture layers disposed in the plurality of apertures;
wherein the plurality of capture layers are manufactured from a porous material further comprising beads.

8. The device of claim 7, wherein the beads are polymer, glass, or ceramic.

9. The device of claim 7, wherein the beads are from 10 microns to 200 microns in diameter.

10. The device of claim 7, wherein the surface chemistry of the beads is reverse phase, ion-exchange, or normal phase.

11. The device of claim 7, wherein the porous material is a hydrophobic porous polymer, a hydrophilic porous polymer, or a mixture of hydrophilic and hydrophobic polymers.

12. The device of claim 8, wherein the capture layers are porous poly(vinylidene difluoride).

13. A method for identifying an analyte by mass spectrometric analysis comprising:
providing the device of claim 1;
placing a sample fluid containing an analyte in the sample well;
applying an electrical current to the sample fluid to effect electrical transport of the analyte through the separation layer and onto the capture layer; and
identifying the mass of analytes on the capture layer in a mass spectrometer.

14. A cartridge capture slide adaptable for use in a mass spectrometer comprising:
an array of apertures disposed in the cartridge capture slide; and
an array of capture layers disposed in the array of apertures;
wherein the array of capture layers are manufactured from a porous material further comprising beads;
wherein the cartridge capture slide is incorporated within a device comprising an array of sample wells and a cartridge gel plate; and
wherein the cartridge gel plate comprises an array of apertures in which are disposed an array of separation layers.

15. The cartridge capture slide of claim 14, wherein the beads are polymer, glass, or ceramic.

16. The cartridge capture slide of claim 14, wherein the beads are from 10 microns to 200 microns in diameter.

17. The cartridge capture slide of claim 14, wherein the surface chemistry of the beads is reverse phase, ion-exchange, or normal phase.

18. The cartridge capture slide of claim 14, wherein the porous material is a hydrophobic porous polymer, a hydrophilic porous polymer, or a mixture of hydrophilic and hydrophobic polymers.

19. The cartridge capture slide of claim 14, wherein the capture layers are porous poly(vinylidene difluoride).
